(19) United States
(12) Patent Application Publication
(10) Pub. No.: US 2026/0315933 A1
(43) Pub. Date: Oct. 15, 2026

(54) SYSTEM AND METHOD FOR MANAGING AVATARS WITH INTEROPERABLE IDENTITY VERIFICATION

(71) Applicant: Cross Game Play LLC, Dacula, GA (US)

(72) Inventors: Kelvin John Troy, Dublin (IE); John Michael O'Connor, Down (IE)

(21) Appl. No.: 19/652,062

(22) Filed: Apr. 20, 2026

Related U.S. Application Data
(63) Continuation-in-part of application No. 19/306,300, filed on Aug. 21, 2025.
Application No. 19/306,300 is a continuation of application No. 18/323,529, filed on May 25, 2023, now Pat. No. 12,420,199.

(51) Int. Cl. A63F 13/63; A63F 13/52; A63F 13/60; A63F 13/79; G06F 8/20; G06F 9/54; G06T 15/00

(52) U.S. Cl. CPC A63F 13/63; A63F 13/52; A63F 13/60; A63F 13/79; G06F 8/20; G06F 9/547; G06T 15/005; A63F 2300/538; A63F 2300/5553; A63F 2300/66

(57) ABSTRACT

A system for cross-platform management of a 3D model of a digital avatar and its associated assets across multiple 3D rendering platforms. The system comprises a content database for storing the 3D model, a user account module for recording asset ownership on a distributed ledger as assertion records in a portable identity container, and a software development kit (SDK) module. An API module receives verification requests and generates a verification plan object (VPO) specifying a disclosure plan and a freshness plan for revocation status. The SDK module includes a validator that enforces the freshness plan by denying authorization when a revocation snapshot package fails specified constraints, enabling offline validation. A conformance gate enables or disables gameplay features based on the authorization decision, creating a trusted and interoperable digital identity system for avatars across gaming platforms.

### CROSS-REFERENCE TO RELATED APPLICATIONS

This application is a continuation-in-part of U.S. patent application Ser. No. 19/306,300 filed Aug. 21, 2025, entitled “SYSTEM AND METHOD FOR MANAGING AVATARS FOR USE IN MULTIPLE 3D RENDERING PLATFORMS”, which is a continuation of U.S. patent application Ser. No. 18/323,529, filed on May 25, 2023, titled “SYSTEM AND METHOD FOR MANAGING AVATARS FOR USE IN MULTIPLE 3D RENDERING PLATFORMS”, issued as U.S. Pat. No. 12,420,199 on Sep. 23, 2025. The previous applications are incorporated herein by reference in their entirety.

### FIELD OF THE PRESENT DISCLOSURE

The present disclosure relates to a system and method for managing avatars and their associated assets across multiple 3D rendering platforms, such as video games, metaverses, and other 3D applications. The disclosure further relates to the fields of computer security, authorization, and digital identity interoperability. More specifically, the present disclosure relates to a system that enables users to create, customize, and maintain a persistent digital avatar or identity with seamless asset interchangeability, and provides a framework for secure, interoperable verification of a user's identity, ownership, and entitlements with minimized disclosure, including support for enforceable offline validation.

### BACKGROUND

With the increasing popularity of virtual worlds, games, and metaverses, users often create and customize avatars to represent themselves in these environments. Many video games, metaverses, and other 3D applications exist that allow users to customize their avatars. These applications can be described as online social interactive platforms, where a user's avatar is how they are identified by other users. Often, these applications feature the ability to purchase cosmetic items to further personalize the avatar. Users meticulously configure their avatars in great detail, to represent themselves precisely the way they desire other users to see them. These avatars are, in a way, a user's identity in the digital world.

However, current avatar customization solutions are typically limited to a single game or platform, resulting in users having to create and manage multiple avatars across different environments. That is, when a user leaves one application and goes to another, the avatar designed in the previous application is confined to the application in which it was created. The user will need to make another avatar, often with very different configuration options, sometimes making it impossible to create a similar avatar. Additionally, any purchased cosmetics are not usable between applications, making them a poor investment. That is, users are unable to transfer their customized avatars or assets, such as clothing or accessories, between different games or platforms. In cases where an application closes down, the avatars and cosmetic purchases are lost forever. Such limitations can be frustrating for users, as they may invest time and resources into customizing their avatars in one environment, only to be unable to use them in another.

Some solutions exist which helps the users to create custom avatars that can be used in various virtual environments. However, these solutions require the users to manually export and import their avatars and associated assets between different environments, which can be cumbersome and time-consuming.

Beyond the challenges of asset portability, existing systems for managing digital identity in gaming and other ecosystems suffer from significant security and privacy limitations. Modern applications require verification of conditions about users, such as ownership of assets, entitlement to features, and trust status, but existing systems are commonly siloed, over-disclosive of user data, network-dependent, and constrained to a single trust model. A particular deficiency in the prior art is the lack of a deterministic, enforceable mechanism that would allow a relying application, such as a game client at a LAN tournament, to validate proofs of a user's status in an offline environment while still being able to enforce revocation freshness to prevent the use of outdated or fraudulent credentials.

### SUMMARY

The present disclosure addresses the aforementioned problems by providing a system and method for managing an avatar for a user for use in multiple 3D rendering platforms. The present disclosure enables users to easily customize and modify their avatars using an SDK and API, allowing them to interchange assets for customization of the avatar at runtime across different games, metaverses, and other real-time 3D rendering environments. The present disclosure also provides a unified system for both managing a portable digital avatar across multiple platforms and for securely verifying conditions related to that avatar and its assets. The avatar management components work in conjunction with the verification framework to create a single, trusted digital identity for the user.

In an aspect of the present disclosure, a system for managing an avatar for a user for use in multiple 3D rendering platforms to be executed in a user device is disclosed. Herein, each one of the multiple 3D rendering platforms comprises a 3D game engine module configured to render the avatar in runtime and an in-engine avatar customization module to allow the user to interchange assets for customization of the avatar at the runtime. The system comprises a content database configured to store a 3D model of the avatar and one or more first assets associated with the 3D model of the avatar, as available with the user. The system further comprises a content delivery module communicatively coupled with the content database. The system further comprises a Software Development Kit (SDK) module adaptively integrated with the in-engine avatar customization module of each one of the multiple 3D rendering platforms. The system further comprises an Application Programming Interface (API) module in communication with the content delivery module and the SDK module. Herein, the SDK module is configured to allow for utilization of the 3D model of the avatar and at least one of the one or more first assets compatible with the corresponding in-engine avatar customization module at the runtime, for the user to customize the avatar by implementing the corresponding in-engine avatar customization module. The API module is configured to receive a first request from the SDK module for the 3D model of the avatar and the at least one of the one or more first assets. The content delivery module is configured to fetch the 3D model of the avatar and the at least one of the one or more first assets from the content database in response to the first request at the API module, for delivery to the SDK module. The SDK module is further configured to fetch one or more second assets utilized by the user for customization of the avatar as available in and by implementation of the corresponding in-engine avatar customization module at the runtime. The API module is further configured to receive a second request from the SDK module for the one or more second assets for storage in the content database. The content delivery module is further configured to fetch the one or more second assets from the SDK module in response to the second request at the API module. The content database is configured to store the one or more second assets therein.

In a further aspect, the system comprises a verification framework configured to prove ownership and other conditions about the user in a privacy-preserving manner. In response to a verification request (VRQ) received from a relying 3D rendering platform, an Application Programming Interface (API) module is configured to generate a verification plan object (VPO). The VPO is a machine-readable plan specifying at least: (i) a disclosure plan defining permitted fields for disclosure to enforce policy-minimized disclosure; (ii) a proof plan identifying a proof type; (iii) a trust-mode plan selected by applying a stored precedence rule table; and (iv) a freshness plan specifying at least one of a minimum epoch or a maximum staleness for revocation status.

In a further aspect, the system comprises a user account module that manages a portable identity container (PIC) for the user, the PIC storing one or more assertion records representing verifiable claims of ownership, achievement, or reputation. In an embodiment, the user account module is configured to implement a distributed ledger for recording the ownership of the 3D model of the avatar and its associated assets, wherein the distributed ledger serves as a source of truth for the ownership assertion records.

In a further aspect, the Software Development Kit (SDK) module further comprises a validator and a conformance gate. The validator is configured to validate a verifiable presentation (VP) generated from an assertion record in the user's PIC. The validation includes enforcing the freshness plan by denying authorization when a selected revocation snapshot package (RSP) fails to satisfy the minimum epoch or maximum staleness constraints. This denial occurs even if the cryptographic proof of the VP otherwise verifies. The conformance gate is configured to enable or disable at least one gameplay feature of the relying 3D rendering platform based on the authorization decision from the validator.

In another aspect, the system further supports offline validation by providing an offline verifier bundle (OVB) to the relying 3D rendering platform, the OVB comprising the signed revocation snapshot packages (RSPs) used by the validator to enforce the freshness plan without requiring a network connection.

In one or more embodiments, the system further comprises a user account module configured to record ownership of the 3D model of the avatar, the one or more first assets and the one or more second assets for the user. In an embodiment, the user account module is configured to implement a distributed ledger for recording the ownership of the 3D model of the avatar, the one or more first assets and the one or more second assets for the user.

In one or more embodiments, the system further comprises a multi-application caching module configured to delete duplicate entries of the 3D model of the avatar, the one or more first assets and the one or more second assets between the multiple 3D rendering platforms in the user device.

In one or more embodiments, the content database and the content delivery module are executed in a server. In an embodiment, the server is a cloud-based server.

In one or more embodiments, the content database and the content delivery module are executed in the user device.

In one or more embodiments, the one or more first assets and the one or more second assets comprises at least one of: separate layer of clothing including shirt, t-shirt, pants, over-jacket; facial features; hair texture; hair color; eye-glasses; make-up features; mask; hat; jewelry; shoes; gloves; music.

In one or more embodiments, the user device comprises at least one of: a personal computer, a smartphone, a gaming console, a portable gaming device, a headset, a heads-up display.

In one or more embodiments, the multiple 3D rendering platforms comprises: video games, metaverses, social virtual reality applications.

In one or more embodiments, the 3D game engine module comprises at least one of: Unity Engine®, Unreal Engine®, Godot Engine®, CryEngine®).

In another aspect of the present disclosure, a method for managing an avatar for a user for use in multiple 3D rendering platforms to be executed in a user device is disclosed. Herein, each one of the multiple 3D rendering platforms comprising a 3D game engine module configured to render the avatar in runtime and an in-engine avatar customization module to allow the user to interchange assets for customization of the avatar at the runtime. The method comprises storing, in a content database, a 3D model of the avatar and one or more first assets associated with the 3D model of the avatar, as available with the user. The method further comprises receiving a command from a user for utilization, via a SDK module integrated with the in-engine avatar customization module of each one of the multiple 3D rendering platforms, of the 3D model of the avatar and at least one of the one or more first assets compatible with the corresponding in-engine avatar customization module at the runtime, to customize the avatar. The method further comprises receiving a first request from the SDK module for the 3D model of the avatar and the at least one of the one or more first assets. The method further comprises fetching the 3D model of the avatar and the at least one of the one or more first assets from the content database in response to the first request, for delivery to the SDK module. The method also comprises fetching one or more second assets utilized by the user for customization of the avatar as available in and by implementation of the corresponding in-engine avatar customization module. The method further comprises receiving a second request from the SDK module for the one or more second assets for storage in the content database. The method further comprises fetching the one or more second assets from the SDK module in response to the second request. The method further comprises storing the one or more second assets in the content database.

In one or more embodiments, the method also comprises recording ownership of the 3D model of the avatar, the one or more first assets and the one or more second assets for the user. In an embodiment, the method comprises implementing a distributed ledger for recording the ownership of the 3D model of the avatar, the one or more first assets and the one or more second assets for the user.

In one or more embodiments, the method also comprises deleting duplicate entries of the 3D model of the avatar, the one or more first assets and the one or more second assets between the multiple 3D rendering platforms in the user device.

In one or more embodiments, the method also comprises executing the content database and the content delivery module in a server.

In one or more embodiments, the method also comprises executing the content database and the content delivery module in the user device.

In an aspect, a computer program is disclosed. The computer program comprises instructions which, when the computer program is executed by a processing unit, cause the processing unit to carry out steps of the aforementioned method.

It is to be appreciated that all the aforementioned implementation forms can be combined. It has to be noted that all devices, elements, circuitry, units, and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity that performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF FIGURES

For a more complete understanding of example embodiments of the present disclosure, reference is now made to the following descriptions taken in connection with the accompanying drawings in which:

FIG. 1 illustrates a diagram of a computing arrangement for implementation of a system for managing an avatar for a user for use in multiple 3D rendering platforms, in accordance with one or more example embodiments of the present disclosure;

FIG. 2 illustrates a diagram of a server, in accordance with one or more example embodiments of the present disclosure;

FIG. 3 illustrates a diagram of a user device, in accordance with one or more example embodiments of the present disclosure;

FIG. 4 illustrates a diagram of a system for managing an avatar for a user for use in multiple 3D rendering platforms, in accordance with one or more example embodiments of the present disclosure;

FIG. 5 illustrates a diagram depicting process flow involved in the system for managing the avatar, in accordance with one or more example embodiments of the present disclosure;

FIG. 6A illustrates an example depiction of a first interface implemented for creating avatar in runtime, in accordance with one or more example embodiments of the present disclosure;

FIG. 6B illustrates an example depiction of a second interface implemented for modelling avatar in runtime, in accordance with one or more example embodiments of the present disclosure;

FIG. 6C illustrates an example depiction of a third interface implemented for customizing avatar in runtime, in accordance with one or more example embodiments of the present disclosure;

FIG. 6D illustrates an example depiction of a fourth interface implemented for finalizing avatar in runtime, in accordance with one or more example embodiments of the present disclosure;

FIG. 7 illustrates a flowchart listing steps involved in a method for managing avatar for a user, in accordance with one or more example embodiments of the present disclosure;

FIG. 8 illustrates a system architecture overview of the interoperable verification system, including a Portable Identity Container (PIC), Verification Plan Object (VPO) engine, Offline Verifier Bundle (OVB)/Revocation Snapshot Package (RSP), schema registry, trust-mode selector, adapters, and interoperability network, in accordance with one or more example embodiments of the present disclosure;

FIG. 9 illustrates the internal structure of a Portable Identity Container (PIC), an export transport package format, and import validation, in accordance with one or more example embodiments of the present disclosure;

FIG. 10 illustrates the flow from a Verification Request (VRQ) to VPO generation, binding, and proof generation, in accordance with one or more example embodiments of the present disclosure;

FIG. 11 illustrates a deterministic trust-mode selection process using a precedence rule table and mode profiles, in accordance with one or more example embodiments of the present disclosure;

FIG. 12 illustrates the contents of an Offline Verifier Bundle (OVB) and the epoch/delta structure of a Revocation Snapshot Package (RSP), in accordance with one or more example embodiments of the present disclosure;

FIG. 13 illustrates a flowchart of an offline validation algorithm including a revocation freshness gate and replay protection, in accordance with one or more example embodiments of the present disclosure;

FIG. 14 illustrates gaming SDK adapter enforcement points, including achievement/reputation gating and anti-cheat trust gates, in accordance with one or more example embodiments of the present disclosure;

FIG. 15 illustrates a cross-game interoperability layer, including a schema registry, issuer scopes, achievement normalization, and reputation aggregation, in accordance with one or more example embodiments of the present disclosure;

FIG. 16 illustrates anti-linkability features including Pairwise Pseudonymous Identifier (PPID) and per-relying-app key derivation with correlation controls, in accordance with one or more example embodiments of the present disclosure; and

FIG. 17 illustrates a hybrid mode combining centralized status signaling with user-held proof and optional delayed synchronization, in accordance with one or more example embodiments of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to the specific details described herein.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Unless specified otherwise in the following description, the terms “perform”, “calculate”, “computer-assisted”, “compute”, “establish”, “generate”, “configure”, “reconstruct”, and the like preferably relate to operations and/or processes and/or processing steps that change and/or generate data and/or convert the data into other data, wherein the data may be represented or be present in particular in the form of physical variables, for example in the form of electrical impulses. The expression “computer” should in particular be interpreted as broadly as possible in order in particular to cover all electronic devices having data processing properties. Computers may thus for example be personal computers, servers, programmable logic controllers (PLCs), hand-held computer systems, pocket PC devices, mobile radio devices and other communication devices able to process data in a computer-assisted manner, processors and other electronic data processing devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Moreover, in particular a person skilled in the art, with knowledge of the method claim/method claims, is aware of all routine possibilities for realizing products or possibilities for implementation in the prior art, and so there is no need in particular for independent disclosure in the description. In particular, these customary realization variants known to the person skilled in the art can be realized exclusively by hardware components or exclusively by software components. Alternatively and/or additionally, the person skilled in the art, within the scope of his/her expert ability, can choose to the greatest possible extent arbitrary combinations according to embodiments of the invention for hardware components and software components in order to implement realization variants according to embodiments of the invention.

Some portions of the detailed description that follows are presented and discussed in terms of a process or method. Although steps and sequencing thereof are disclosed in figures herein describing the operations of this method, such steps and sequencing are examples. Embodiments are well suited to performing various other steps or variations of the steps recited in the flowchart of the figure herein, and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. In present implementations, the used language for training may be one of Python, Tensorflow, Bazel, C, C++. Further, decoder in user device (as will be discussed) may use C, C++ or any processor specific ISA. Furthermore, assembly code inside C/C++ may be utilized for specific operation. Also, ASR (automatic speech recognition) and G2P decoder along with entire user system can be run in embedded Linux® (any distribution), Android®, iOS®, Windows®, or the like, without any limitations. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

The present disclosure provides a solution that allows users to maintain a persistent avatar across multiple 3D applications and legitimately own all of their cosmetic purchases. This offers users the ability to have a persistent digital avatar or identity across the digital world.

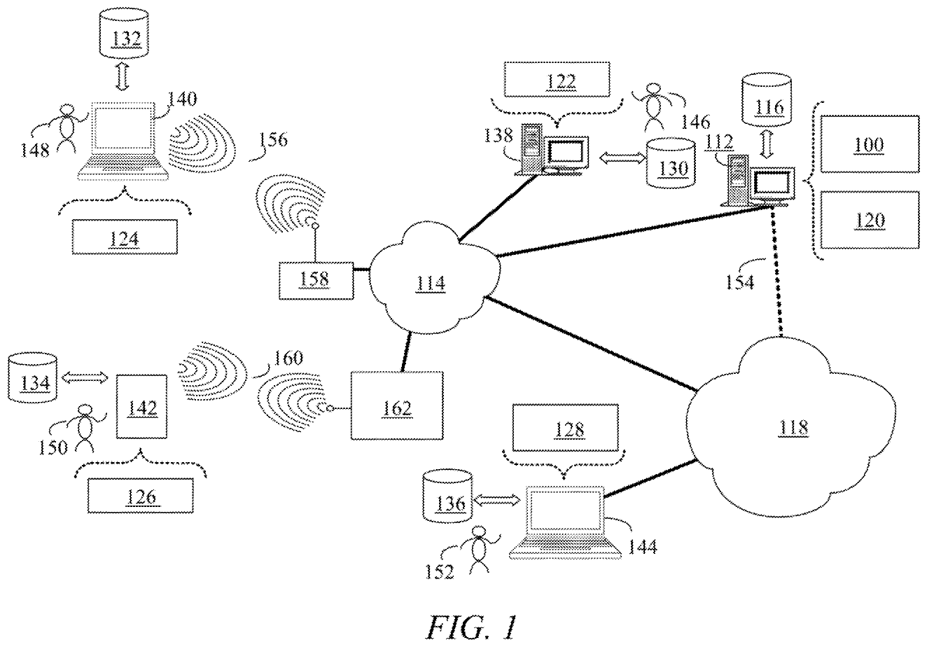

Referring to example implementation of FIG. 1, there is shown a computing arrangement 100 that may reside on and may be executed by a computer (e.g., computer 112), which may be connected to a network (e.g., network 114) (e.g., the internet or a local area network). Examples of computer 112 may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 112 may execute an operating system, for example, but not limited to, Microsoft Windows®; Mac OS X®; Red Hat Linux®, or a custom operating system.

In some implementations, the instruction sets and subroutines of computing arrangement 100, which may be stored on storage device, such as storage device 116, coupled to computer 112, may be executed by one or more processors (not shown) and one or more memory architectures included within computer 112. In some implementations, storage device 116 may include but is not limited to: a hard disk drive; a flash drive, a tape drive; an optical drive; a RAID array (or other array); a random-access memory (RAM); and a read-only memory (ROM).

In some implementations, network 114 may be connected to one or more secondary networks (e.g., network 118), examples of which may include but are not limited to: a local area network; a wide area network; or an intranet, for example.

In some implementations, computer 112 may include a data store, such as a database (e.g., relational database, object-oriented database, triplestore database, etc.) and may be located within any suitable memory location, such as storage device 116 Coupled to computer 112. In some implementations, data, metadata, information, etc. described throughout the present disclosure may be stored in the data store. In some implementations, computer 112 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, computing arrangement 100 may be a component of the data store, a standalone application that interfaces with the above noted data store and/or an applet/application that is accessed via client applications 122, 124, 126, 128. In some implementations, the above noted data store may be, in whole or in part, distributed in a cloud computing topology. In this way, computer 112 and storage device 116 may refer to multiple devices, which may also be distributed throughout the network.

In some implementations, computer 112 may execute application 120 for managing an avatar for a user for use in multiple 3D rendering platforms. In some implementations, computing arrangement 100 and/or application 120 may be accessed via one or more of client applications 122, 124, 126, 128. In some implementations, computing arrangement 100 may be a standalone application, or may be an applet/application/script/extension that may interact with and/or be executed within application 120, a component of application 120, and/or one or more of client applications 122, 124, 126, 128. In some implementations, application 120 may be a standalone application, or may be an applet/application/script/extension that may interact with and/or be executed within computing arrangement 100, a component of computing arrangement 100, and/or one or more of client applications 122, 124, 126, 128. In some implementations, one or more of client applications 122, 124, 126, 128 may be a standalone application, or may be an applet/application/script/extension that may interact with and/or be executed within and/or be a component of computing arrangement 100 and/or application 120. Examples of client applications 122, 124, 126, 128 may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications 122, 124, 126, 128, which may be stored on storage devices 130, 132, 134, 136, coupled to user devices 138, 140, 142, 144, may be executed by one or more processors and one or more memory architectures incorporated into user devices 138, 140, 142, 144.

In some implementations, one or more of storage devices 130, 132, 134, 136, may include but are not limited to: hard disk drives; flash drives, tape drives; optical drives; RAID arrays; random access memories (RAM); and read-only memories (ROM). Examples of user devices 138, 140, 142, 144 (and/or computer 112) may include, but are not limited to, a personal computer (e.g., user device 138), a laptop computer (e.g., user device 140), a smart/data-enabled, cellular phone (e.g., user device 142), a notebook computer (e.g., user device 144), a tablet (not shown), a server (not shown), a television (not shown), a smart television (not shown), a media (e.g., video, photo, etc.) capturing device (not shown), and a dedicated network device (not shown). User devices 138, 140, 142, 144 may each execute an operating system, examples of which may include but are not limited to, Android, Apple IOS, Mac OS X; Red Hat Linux, or a custom operating system.

In some implementations, one or more of client applications 122, 124, 126, 128 may be configured to effectuate some or all of the functionality of computing arrangement 100 (and vice versa). Accordingly, in some implementations, computing arrangement 100 may be a purely server-side application, a purely client-side application, or a hybrid server-side/client-side application that is cooperatively executed by one or more of client applications 122, 124, 126, 128 and/or computing arrangement 100.

In some implementations, one or more of client applications 122, 124, 126, 128 may be configured to effectuate some or all of the functionality of application 120 (and vice versa). Accordingly, in some implementations, application 120 may be a purely server-side application, a purely client-side application, or a hybrid server-side/client-side application that is cooperatively executed by one or more of client applications 122, 124, 126, 128 and/or application 120. As one or more of client applications 122, 124, 126, 128, computing arrangement 100, and application 120, taken singly or in any combination, may effectuate some or all of the same functionality, any description of effectuating such functionality via one or more of client applications 122, 124, 126, 128, computing arrangement 100, application 120, or combination thereof, and any described interaction(s) between one or more of client applications 122, 124, 126, 128, computing arrangement 100, application 120, or combination thereof to effectuate such functionality, should be taken as an example only and not to limit the scope of the disclosure.

In some implementations, one or more of users 146, 148, 150, 152 may access computer 112 and computing arrangement 100 (e.g., using one or more of user devices 138, 140, 142, 144) directly through network 114 or through secondary network 118. Further, computer 112 may be connected to network 114 through secondary network 118, as illustrated with phantom link line 154. Computing arrangement 100 may include one or more user interfaces, such as browsers and textual or graphical user interfaces, through which users 146, 148, 150, 152 may access computing arrangement 100.

In some implementations, the various user devices may be directly or indirectly coupled to communication network, such as communication network 114 and communication network 118, hereinafter simply referred to as network 114 and network 118, respectively. For example, user device 138 is shown directly coupled to network 114 via a hardwired network connection. Further, user device 144 is shown directly coupled to network 118 via a hardwired network connection. User device 140 is shown wirelessly coupled to network 114 via wireless communication channel 156 established between user device 140 and wireless access point (i.e., WAP) 158, which is shown directly coupled to network 114. WAP 158 may be, for example, an IEEE 802.11a, 802.11b, 802.11g, Wi-Fi, RFID, and/or Bluetooth (including Bluetooth Low Energy) device that is capable of establishing wireless communication channel 156 Between user device 140 and WAP 158. User device 142 is shown wirelessly coupled to network 114 via wireless communication channel 160 established between user device 142 and cellular network/bridge 162, which is shown directly coupled to network 114.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example, Bluetooth (including Bluetooth Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

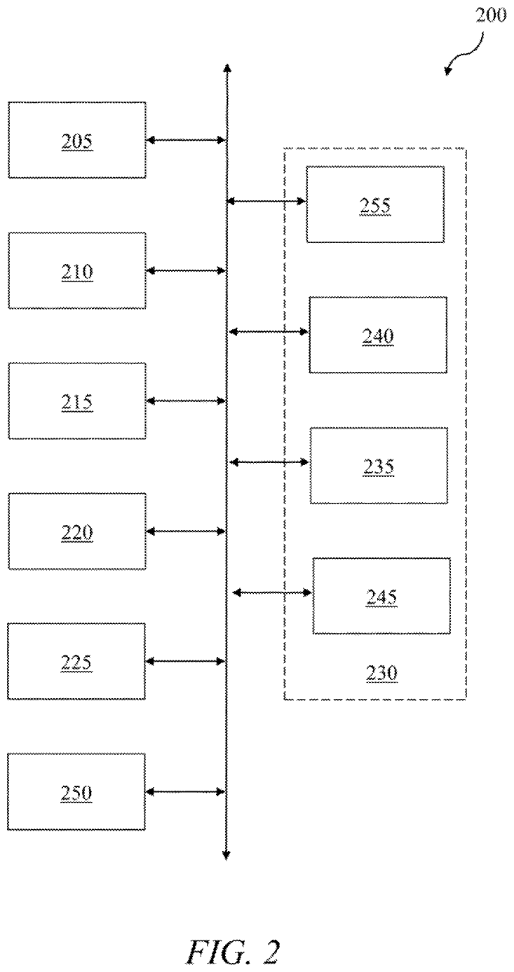

The computing arrangement 100 may include a server (such as server 200, as shown in FIG. 2) for managing an avatar for a user for use in multiple 3D rendering platforms. In the present implementations, the computing arrangement 100 itself may be embodied as the server 200. Herein, FIG. 2 is a block diagram of an example of the server 200 capable of implementing embodiments according to the present disclosure. In the example of FIG. 2, the server 200 may include a processing unit 205 for running software applications (such as, the application 120 of FIG. 1) and optionally an operating system. As illustrated, the server 200 may further include a database 210 which stores applications and data for use by the processing unit 205. Storage 215 provides non-volatile storage for applications and data and may include fixed disk drives, removable disk drives, flash memory devices, and CD-ROM, DVD-ROM or other optical storage devices. An optional user input device 220 may include devices that communicate user inputs from one or more users to the server 200 and may include keyboards, mice, joysticks, touch screens, etc. A communication or network interface 225 is provided which allows the server 200 to communicate with other computer systems via an electronic communications network, including wired and/or wireless communication and including an Intranet or the Internet. In one embodiment, the server 200 receives instructions and user inputs from a remote computer through communication interface 225. Communication interface 225 can comprise a transmitter and receiver for communicating with remote devices. An optional display device 250 may be provided which can be any device capable of displaying visual information in response to a signal from the server 200. The components of the server 200, including the processing unit 205, the database 210, the data storage 215, the user input devices 220, the communication interface 225, and the display device 250, may be coupled via one or more data buses, such as data bus 260.

In the embodiment of FIG. 2, a graphics system 230 may be coupled with the data bus 260 and the components of the server 200. The graphics system 230 may include a physical graphics processing arrangement (GPU) 235 and graphics memory. The GPU 235 generates pixel data for output images from rendering commands. The physical GPU 235 can be configured as multiple virtual GPUs that may be used in parallel (concurrently) by a number of applications or processes executing in parallel. For example, mass scaling processes for rigid bodies or a variety of constraint solving processes may be run in parallel on the multiple virtual GPUs. Graphics memory may include a display memory 240 (e.g., a framebuffer) used for storing pixel data for each pixel of an output image. In another embodiment, the display memory 240 and/or additional memory 245 may be part of the database 210 and may be shared with the processing unit 205. Alternatively, the display memory 240 and/or additional memory 245 can be one or more separate memories provided for the exclusive use of the graphics system 230. In another embodiment, the graphics system 230 may include one or more additional physical GPUs 255, similar to the GPU 235. Each additional GPU 255 may be adapted to operate in parallel with the GPU 235. Each additional GPU 255 generates pixel data for output images from rendering commands. Each additional physical GPU 255 can be configured as multiple virtual GPUs that may be used in parallel (concurrently) by a number of applications or processes executing in parallel, e.g., processes that solve constraints. Each additional GPU 255 can operate in conjunction with the GPU 235, for example, to simultaneously generate pixel data for different portions of an output image, or to simultaneously generate pixel data for different output images. Each additional GPU 255 can be located on the same circuit board as the GPU 235, sharing a connection with the GPU 235 to the data bus 260, or each additional GPU 255 can be located on another circuit board separately coupled with the data bus 260. Each additional GPU 255 can also be integrated into the same module or chip package as the GPU 235. Each additional GPU 255 can have additional memory, similar to the display memory 240 and additional memory 245, or can share the memories 240 and 245 with the GPU 235. It is to be understood that the circuits and/or functionality of GPU as described herein could also be implemented in other types of processors, such as general-purpose or other special-purpose coprocessors, or within a CPU.

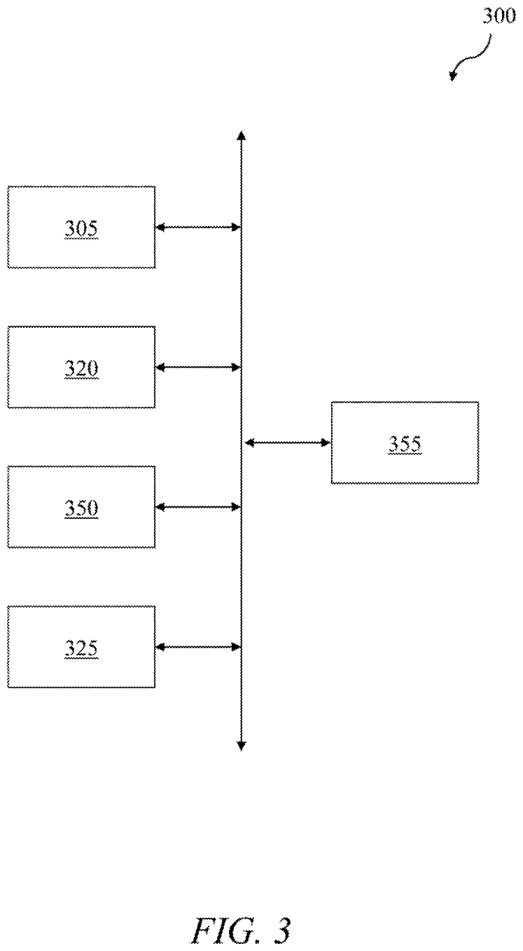

The computing arrangement 100 may also include a user device 300 (as shown in FIG. 3). In embodiments of the present disclosure, the user device 300 may embody a smartphone, a personal computer, a tablet, or the like. Herein, FIG. 3 is a block diagram of an example of the user device 300 capable of implementing embodiments according to the present disclosure. In the example of FIG. 3, the user device 300 may include a processor 305 (hereinafter, referred to as a CPU) for running software applications (such as, the application 120 of FIG. 1) and optionally an operating system. A user input device 320 is provided which may include devices that communicates user inputs from one or more users and may include keyboards, mice, joysticks, touch screens, and/or microphones. Further, a network adapter 325 is provided which allows the user device 300 to communicate with other computer systems (e.g., the server 200 of FIG. 2) via an electronic communications network, including wired and/or wireless communication and including the Internet. The user device 300 may also include a decoder 355 may be any device capable of decoding (decompressing) data that may be encoded (compressed). A display device 350 may be provided which may be any device capable of displaying visual information, including information received from the decoder 355. In particular, as will be described below, the display device 350 may provide an interface, such that the display device 350 is configured to display information received from the server 200 of FIG. 2. The components of the user device 300 may be coupled via one or more data buses 360.

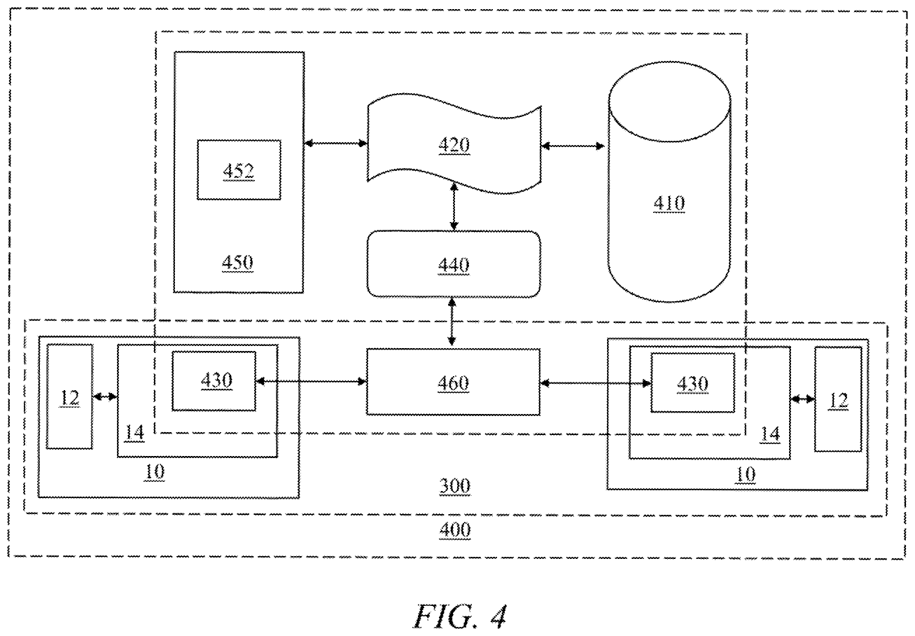

Referring to FIG. 4, illustrated is an example block diagram of a system 400 for managing an avatar for a user for use in multiple 3D rendering platforms (as represented by reference numeral 10). The system 400, as described in the present disclosure, is integrated within the computing arrangement 100, and may be specifically implemented in the user device 300 in combination with (or without) the server 200 of the computing arrangement 100. Herein, the server 200 may manage and coordinate the necessary data, processing, and communication involved in the proper functioning of the system 400. Simultaneously, the user device 300 may serve as an interactive interface for users to engage with the system 400, offering customization options, access to assets, and seamless interaction with the multiple real-time 3D rendering platforms. By implementing the system 400 within the server 200 and the user device 300, the present invention ensures a comprehensive and coherent framework for creating and customizing avatars, as well as providing a consistent user experience across various games, metaverses, or any other real-time 3D rendered environments.

In context of the present disclosure, the 3D rendering platforms 10 refer to various interactive digital environments that utilize real-time 3D graphics to display and navigate within their respective virtual worlds. The 3D rendering platforms 10 cater to different audiences and purposes, creating diverse experiences that rely on 3D graphics technology for realistic and engaging interactions. In present examples, the 3D rendering platforms 10 may be real-time rendering platforms, in which the real-time aspect signifies that the graphical content is continuously rendered and updated based on user interactions, ensuring a responsive and dynamic experience. Real-time 3D graphics technology enables the rendering of 3D scenes, objects, and characters with rapid updates based on user inputs or changing conditions within the virtual environment. Such technology relies on sophisticated algorithms and hardware acceleration to achieve smooth and fluid visuals, allowing users to experience an immersive, dynamic, and interactive environment.

Specifically, in embodiments of the present disclosure, the 3D rendering platforms 10 include those platforms that provide an avatar for the user, allowing the users to represent themselves within the virtual environment. As used herein, an avatar is a customizable digital representation of the user within the virtual environment. The avatar may take various forms, ranging from human-like characters to fantastical creatures or abstract entities, depending on the specific platform and user preferences. The avatar serves as the user's digital identity, allowing them to interact with other users and the virtual environment. The objective of the present disclosure is to enable users to maintain a consistent and persistent avatar across these diverse platforms, enhancing their experience and digital identity. The system 400 of the present disclosure aims to manage the avatars for the user, so that these avatars may be used across various 3D rendering platforms 10, allowing users to maintain a consistent and persistent digital identity throughout their online experiences.

For purposes of the present disclosure, the multiple 3D rendering platforms 10 encompass a wide range of interactive digital environments, including video games, metaverses, and social virtual reality applications. Video games are interactive entertainment experiences that involve real-time 3D graphics to create immersive environments for players to navigate and engage with. They can span various genres, such as role-playing games (RPGs), first-person shooters (FPS), and massively multiplayer online games (MMOs). Metaverses are expansive, interconnected virtual worlds that allow users to explore, socialize, and participate in various activities. These digital spaces provide a platform for users to create and customize their own avatars, build virtual environments, and interact with other users in real-time. Metaverses can be used for a wide range of purposes, including entertainment, education, social networking, c-commerce, and collaborative workspaces. Social virtual reality applications are platforms that utilize virtual reality (VR) technology to create immersive social experiences for users. These applications enable users to interact with others in a shared virtual environment, using avatars as their digital representations. In each of these 3D rendering platforms, avatars play a critical role in representing users and enabling them to interact within the virtual environment.

As may be contemplated, each one of the multiple 3D rendering platforms 10 may include a 3D game engine module (as represented by reference numeral 12) configured to render the avatar in runtime. The 3D game engine module 12 is a software framework designed for the development and execution of interactive 3D applications, such as video games, simulations, and virtual environments. The 3D game engine module 12 provides a range of tools and functionalities, including rendering, physics, animation, and artificial intelligence, that enable developers to create immersive and interactive experiences. Rendering is the process of converting the digital representation of an avatar, including its geometry, textures, and animations, into a visually coherent form that can be displayed on the user's device. As used herein, runtime refers to the period during which a 3D application or game is actively executing and being interacted with by the user. In contrast to the development phase, where assets and functionalities are being created and integrated, runtime encompasses the actual experience of the user as they navigate and interact within the 3D environment.

Herein, the 3D game engine module 12 may include at least one of the following popular and widely-used game engines, such as Unity Engine®, Unreal Engine®, Godot Engine® CryEngine®. Each of these game engines offers unique capabilities and advantages, and the present disclosure may be implemented using any one or a combination of these engines to create a seamless and persistent avatar experience across the multiple 3D rendering platforms 10. By leveraging the capabilities of the 3D game engine module 12, the avatar can be rendered in real-time, allowing for smooth and responsive interaction with the virtual environment and other users. In addition to rendering the avatar, the 3D game engine module 12 may also manage other aspects of the avatar's behavior and appearance during runtime, such as handling animation, collision detection, and physics interactions. This ensures that the user's avatar behaves and reacts realistically within the context of the 3D rendering platform 10, providing a seamless and immersive experience.

Further, each one of the multiple 3D rendering platforms 10 may include an in-engine avatar customization module (as represented by reference numeral 14) to allow the user to interchange assets for customization of the avatar at the runtime. That is, the in-engine avatar customization module 14 enables the users to seamlessly interchange and modify assets of their avatar in real-time while they are using the 3D rendering platforms 10. The in-engine avatar customization module 14 allows for a more dynamic and personalized experience by providing users with the ability to make adjustments to their avatars without having to leave the platform or restart the application. By offering these customization options and more within the 3D rendering platforms 10, the in-engine avatar customization module 14 significantly enhances the user experience, promoting a deeper sense of identity and personalization within the digital world.

### Definitions

The following definitions are provided to enable a person skilled in the art to make and use the disclosed embodiments.
Portable Identity Container (PIC): A portable, exportable data structure associated with a subject that stores assertion records, cryptographic keys, status references, and policy metadata.
Assertion Record: A verifiable claim representing at least one of ownership, entitlement, achievement, reputation metric, role, consent, or trust status, including validity and a revocation status reference.
Verification Request (VRQ): A message from a relying application including a required condition, a relying_app_id, one or more context/risk tags, and a challenge nonce.
Verification Plan Object (VPO): A machine-readable plan generated for a VRQ specifying minimized disclosure, proof type, trust mode, freshness requirements, and enforcement actions; cryptographically bound to the VRQ context.
Offline Verifier Bundle (OVB): Local materials for offline verification, including trust anchors and one or more revocation snapshot packages.
Revocation Snapshot Package (RSP): A signed status package associated with an epoch, which may include deltas and inclusion/exclusion proofs.
Schema Registry: A repository (local or networked) of assertion schemas, versions, and normalization mappings for cross-application or cross-game compatibility.
Issuer Scope Rules: Rules indicating which issuer(s) may issue which assertion types and under what constraints.
Reputation Aggregation Rule Engine: An engine that computes a derived reputation or trust score from multiple verified assertions using deterministic formulas.
Pairwise Pseudonymous Identifier (PPID): An identifier derived uniquely per relying application (and optionally per context) to reduce correlation.
Precedence Rule Table: A deterministic mapping from partner policy, jurisdiction, risk, and network state to a selected trust mode.

As used herein, the assets refer to a wide range of customizable elements or components that users can apply to their avatars in order to personalize and enhance their digital personas. These assets helps in creating a unique and distinctive appearance for each user's avatar, contributing to a more immersive and engaging experience across the 3D rendering platforms 10. The assets may encompass a diverse array of customizable elements, including separate layer of clothing including shirt, t-shirt, pants, over-jacket; facial features; hair texture; hair color; eye-glasses; make-up features; mask; hat; jewelry; shoes; gloves; music. The separate layers of clothing such as shirts, t-shirts, pants, and over-jackets allow users to mix and match different styles and outfits, and can be layered on top of each other. Additionally, users can modify facial features to create a desired expression or resemblance, while hair texture and color options provide further customization possibilities. Accessories such as eye-glasses, make-up features, masks, hats, and jewelry can be added or removed to give the avatar a unique look. Further, users can choose from a variety of shoes and gloves to complete their avatars' outfits. Furthermore, music can serve as an audio asset that adds a personal touch to the user's digital persona. Users can select a specific track, melody, or sound effect to accompany their avatar, creating a unique auditory signature that reflects their taste and style. By providing a comprehensive selection of assets, the present invention enables users to tailor their digital identities to their personal preferences, fostering a greater sense of individuality and self-expression within the virtual worlds of 3D rendering platforms.

As discussed, the in-engine avatar customization module 14 offers users the ability to effortlessly interchange and modify their avatars' assets in real-time as they engage with the 3D rendering platforms 10. Swapping outfits is one example, as users within a metaverse or virtual social space may wish to alter their avatars' clothing to suit a specific theme or event. The in-engine avatar customization module 14 facilitates easy transitions between various outfits or clothing pieces, rendering avatars readily adaptable to diverse situations. Additionally, the in-engine avatar customization module 14 permits users to adjust facial features to convey a particular emotion or more accurately reflect their real-life appearance, thereby enhancing the authenticity and personal connection with their digital personas. Accessory customization is another feature of the in-engine avatar customization module 14, enabling users to add or remove items such as hats, glasses, or jewelry for an added layer of personalization. Users can conveniently experiment with a range of accessory combinations to achieve their desired look or style. Changing hairstyles is also made possible through the in-engine avatar customization module 14, allowing users to modify their avatars' hairstyles to suit their preferences or to align with a specific event or theme, all without leaving the 3D rendering platform 10. Lastly, the in-engine avatar customization module 14 may incorporate in-game items, wearables, or assets acquired within a specific game or platform into the user's avatar. This functionality enables users to display their in-game achievements or purchases across multiple 3D rendering platforms 10.

In present examples, the 3D rendering platforms 10 may be executed in a user device (such as, the user device 300). That is, these 3D rendering platforms 10 can be accessed by users through their user devices 300, which encompass a wide range of hardware and form factors to provide versatile and convenient access to the virtual worlds. For purposes of the present disclosure, the user device 300 may include various types of hardware that allow users to access and interact with the 3D rendering platforms 10. In present embodiments, the user device 300 may include at least one of: a personal computer, a smartphone, a gaming console, a portable gaming device, a headset, a heads-up display. Herein, a personal computer, for example, can be a desktop or laptop computer that enables users to run gaming applications, virtual worlds, or metaverse platforms, providing a wide range of customization and interaction options through peripherals such as a keyboard, mouse, or gaming controllers. A smartphone, on the other hand, offers a portable and convenient way for users to access these platforms through mobile applications, utilizing touch-based controls and built-in sensors for interaction. Gaming consoles, such as PlayStation®, Xbox®, or Nintendo Switch®, provide a dedicated platform for gaming experiences, including online multiplayer games and social virtual worlds, often with specialized controllers for intuitive input. Portable gaming devices, like the Nintendo Switch Lite or PlayStation Vita, combine the convenience of a mobile device with dedicated gaming hardware, allowing users to engage with their avatars on-the-go. Headsets, such as VR or augmented reality (AR) devices, immerse users in the virtual environment, providing an even more immersive and intuitive experience through natural movements and gestures. Finally, heads-up displays, like Google Glass or other smart glasses, overlay digital information onto the user's view of the real world, enabling seamless integration between the virtual and physical realms. Each of these user devices 300 allows users to interact with their avatars across the said multiple 3D rendering platforms 10.

According to an embodiment, as illustrated in FIG. 4, the system 400 of the present disclosure includes a content database 410 configured to store a 3D model of the avatar and one or more assets associated with the 3D model of the avatar, as available with the user; a content delivery module 420 communicatively coupled with the content database 410, and configured to fetch the avatar and the assets from the content database 410 and deliver the required data as required; a SDK module 430 adapted to be integrated with the in-engine avatar customization module 14 of each one of the multiple 3D rendering platforms 10, and configured to allow for utilization of the said 3D model of the avatar and at least one of the said one or more assets compatible with the corresponding in-engine avatar customization module at the runtime, for the user to customize the avatar by implementing the said corresponding in-engine avatar customization module; and an API module 440 in communication with the content delivery module 420 and the SDK module 430, and configured to process requests from the SDK module 430 for avatar and asset data from the content database 410 via the content delivery module 420.

In particular, the content database 410 is designed to store and manage the 3D models of avatars along with one or more assets associated with each respective 3D model of the avatar. The content database 410 ensures that the user's avatar and associated assets are readily available for use across various real-time 3D rendering platforms 10. By housing the 3D models of user avatars and their associated assets in a centralized location, the content database 410 enables efficient data management and retrieval, facilitating seamless access and interaction with the avatars across multiple 3D rendering platforms 10. The content database 410 may also ensure that user avatars and associated assets are compatible with different real-time 3D rendering platforms 10. Metadata associated with each avatar and asset may also be stored in the content database 410. This metadata may include, but is not limited to, asset type, asset category, asset creator information, and asset ownership information.

In some examples, the content database 410 may also support versioning for avatars and assets, enabling users to maintain multiple versions of their avatar or individual assets. This feature allows users to revert to a previous version of their avatar or asset if desired, providing an additional level of customization and control. In some examples, the content database 410 may be configured with appropriate access control mechanisms, ensuring that users can access and modify their own avatars and associated assets, and optionally only their own avatars and associated assets. These access controls may include authentication, authorization, and encryption techniques to protect user data and maintain privacy. The content database 410 may also be structured in a hierarchical manner, with each user's avatar and its associated assets grouped together. The content database 410 may utilize a scalable and efficient storage system that can accommodate the growing number of avatars and associated assets. Such storage system may employ a combination of relational databases, NoSQL databases, and/or distributed file systems to ensure the optimal organization and retrieval of data. To further enhance the performance of the content database, various optimization techniques may be employed, such as caching, indexing, and load balancing. These techniques help ensure that the content database can efficiently serve avatars and assets to users across multiple real-time 3D rendering platforms, even under high-traffic conditions.

The SDK module 430 enables the integration and seamless interoperability of the in-engine avatar customization module 14 across the multiple 3D rendering platforms 10. The SDK module 430 provides developers with the necessary tools, libraries, and guidelines to implement the system's functionalities within the respective 3D rendering platforms 10. Specifically, the SDK module 430 facilitates the utilization of the 3D model of the avatar and at least one of the assets stored in the content database 410, ensuring compatibility with the corresponding in-engine avatar customization module 14. By integrating the SDK module 430 into the 3D rendering platforms 10, developers can enable users to customize their avatars using the available assets (and any additional second assets, as discussed later in the description) in real-time, during runtime of the corresponding 3D rendering platform 10. Thus, the SDK module 430 serves as a link in the system 400, bridging the gap between the content database 410, and the in-engine avatar customization module 14 and the multiple 3D rendering platforms 10.

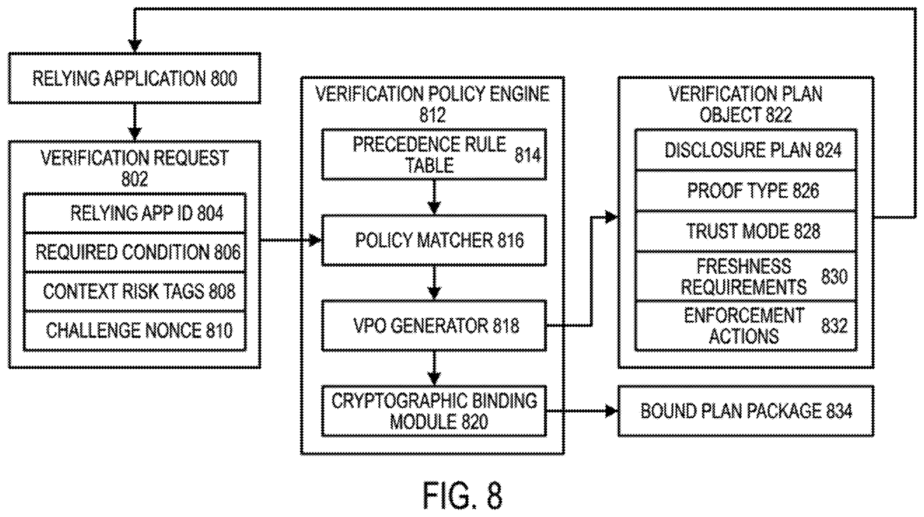

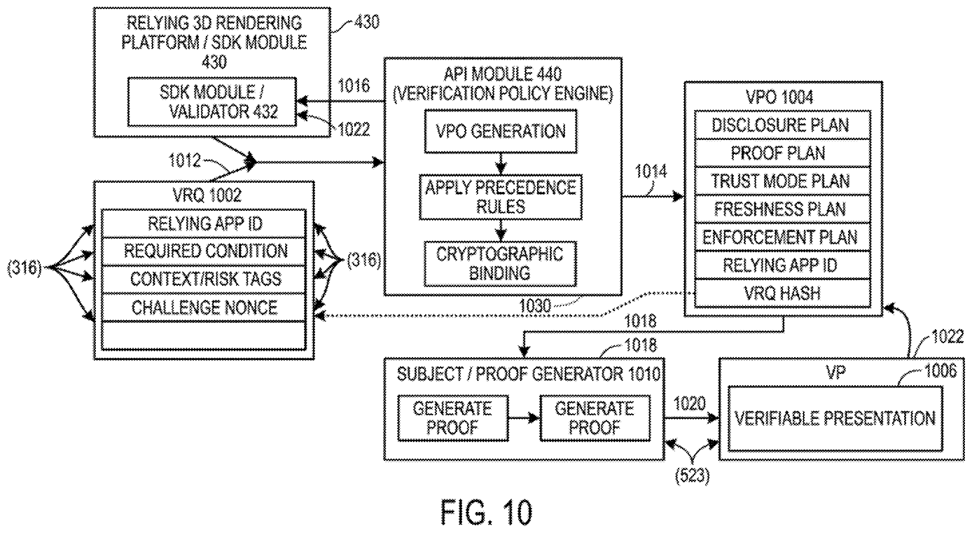

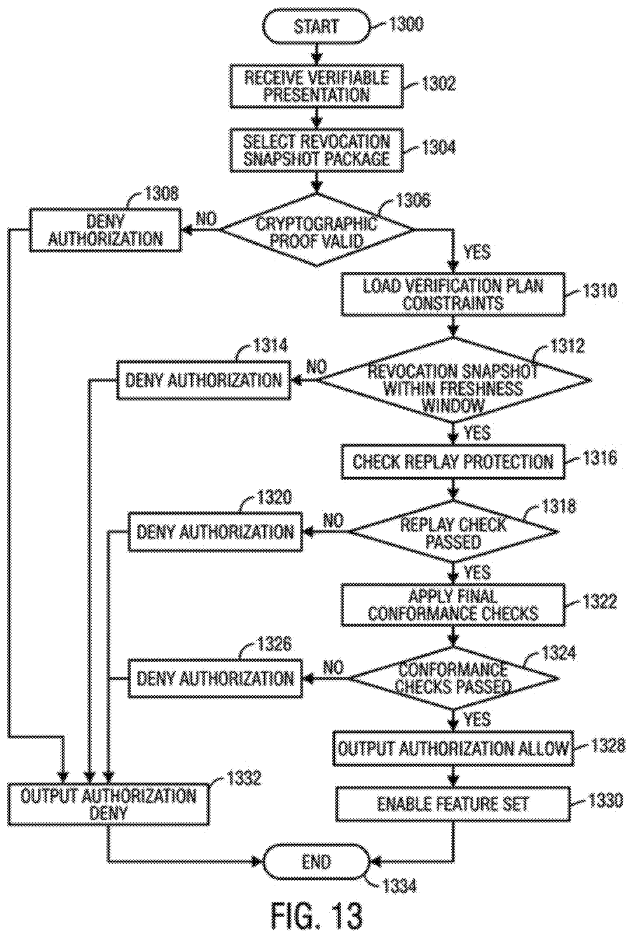

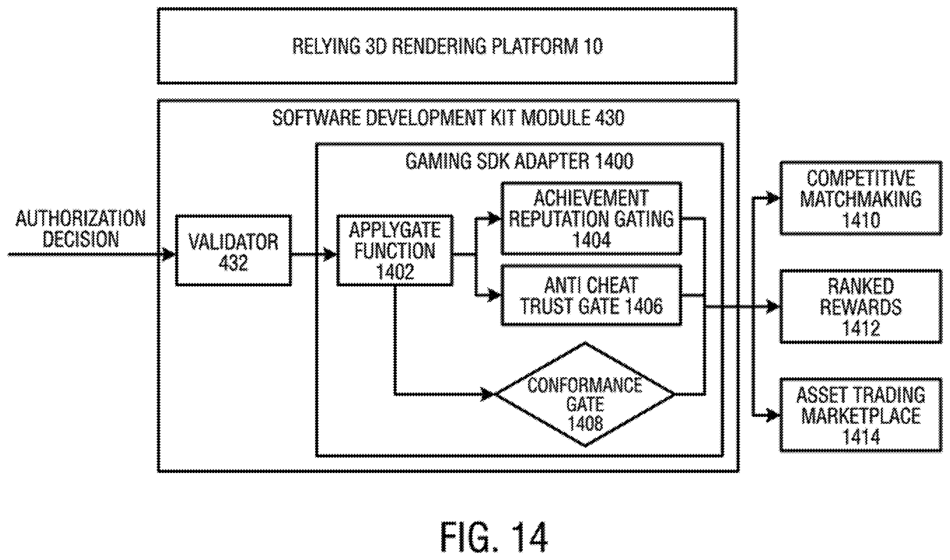

In a further embodiment, as illustrated in FIG. 8 and FIG. 14, the SDK module 430 is additionally configured to initiate a verification process when a relying application requires proof of a condition about a user (e.g., ownership of a specific asset, a minimum reputation score). The SDK module 430 initiates this by sending a Verification Request (VRQ) to the API module 440, as shown in the flow of FIG. 10. The SDK module 430 further comprises or interfaces with a validator component. As shown in the algorithm of FIG. 13, this validator is configured to receive a Verifiable Presentation (VP) from the user and validate it against a Verification Plan Object (VPO). The SDK module 430 further exposes one or more conformance gate functions, such as an ApplyGate( ) function. As illustrated in FIG. 14, this function is executed prior to enabling competitive or restricted features (e.g., matchmaking, ranked rewards, asset trading) and enables or disables said features based on the authorization decision output by the validator. The SDK denies enabling such features when verification fails, for example, due to a revocation freshness failure, an invalid proof, or a policy violation.

It may be understood that the SDK module 430 takes into consideration the unique requirements and specifications of the corresponding in-engine avatar customization module 14 when allowing for the utilization of the 3D model of the avatar and at least one of the assets. This involves converting or adapting the 3D model and assets into a format that can be readily understood and processed by the in-engine avatar customization module. The SDK module 430 may also account for any differences in the way assets are handled, rendered, or animated across different 3D rendering platforms 10, ensuring that the avatar and associated assets maintain their intended appearance and functionality regardless of the 3D rendering platform 10. It may also be appreciated that in addition to providing compatibility between with the multiple 3D rendering platforms 10, the SDK module 430 may also help maintain a consistent user experience. The SDK module 430 ensures that the avatar customization features are accessible and function similarly across different 3D rendering platforms 10, thereby allowing the users to modify their avatars quickly and easily without encountering platform-specific limitations or discrepancies. Furthermore, the SDK module enables the developers to add or update avatar assets, customization options, and other features as needed, ensuring that the system 400 remains adaptable and up-to-date with evolving user preferences and industry trends.

The API module 440 facilitates seamless communication between various components, such as the content delivery module 420, the SDK module 430, and other integrated services in the system 400. By providing a standardized set of protocols, conventions, and functions, the API module 440 ensures that different parts of the system 400 can efficiently exchange information and work together harmoniously. Specifically, herein, the API module 440 is configured to receive a request from the SDK module 430 for specific resources, such as the 3D model of the avatar and the associated assets. Upon receiving the request, the API module 440 processes the request and communicates with the content delivery module 420 to retrieve the requested data. After acquiring the necessary information, the API module 440 sends the data back to the SDK module 430, which in turn utilizes the data to customize and render the avatar within the corresponding 3D rendering platform 10. It may be appreciated that, additionally, the API module 440 may also serve as an abstraction layer in the system 400, shielding the internal workings of the system 400 and providing a simplified interface for developers to work with. This allows developers to focus on building and customizing their avatars and assets without needing to delve into the intricacies of underlying architecture the system 400.

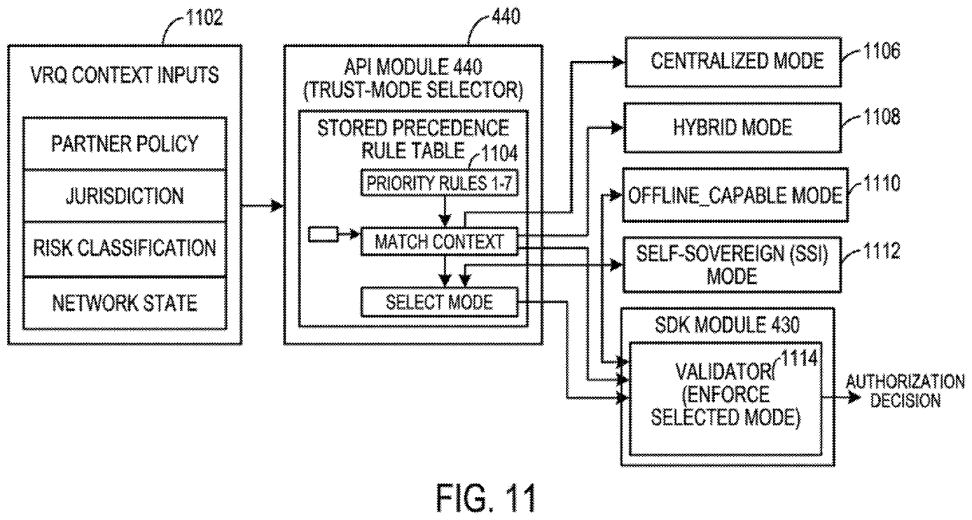

In a further embodiment, expanding on its communication role, the API module 440 additionally functions as a verification policy engine, as illustrated in the flow of FIG. 10. It is configured to receive a Verification Request (VRQ) from the SDK module 430, the VRQ comprising at least a relying-application identifier and a required condition. In response, the API module 440 is configured to generate a Verification Plan Object (VPO). The VPO is a machine-readable plan specifying at least: (i) a disclosure plan comprising an allowed_fields list to enforce policy-minimized disclosure; (ii) a proof plan identifying a required proof type; (iii) a trust-mode plan selected by applying a stored precedence rule table as shown in FIG. 11, which maps partner policy, jurisdiction, risk classification, or network state to a selected mode; and (iv) a freshness plan specifying at least one of a minimum epoch or a maximum staleness for revocation status. The API module 440 cryptographically binds the VPO to the VRQ to prevent replay and context substitution.

An illustrative, non-limiting example of a VPO schema is as follows:

```
{
  “vpo_version”: “1.0”,
  “vpo_id”: “uuid”,
  “vrq_hash”: “H(VRQ)”,
  “relying_app_id”: “app://publisher/game_id”,
  “context”: {
    “domain”: “gaming|healthcare|enterprise|commerce”,
    “risk”: “low|medium|high”,
    “jurisdiction”: “US-CA|EU-IE|...”,
    “network_state”: “online|degraded|offline”
  },
  “required_condition”: {
    “type”: “ownership|entitlement|achievement|reputation|role|consent|trust”,
    “predicate”: “owns(asset:X) OR achievement(A) OR reputation>=R”,
    “schema_id”: “schema://achievements/v3”
  },
  “disclosure_plan”: {
    “allowed_records”: [“record_id_1”, “record_id_2”],
    “allowed_fields”: [“type”,“issuer_id”,“validity”,“predicate_fields”],
    “withheld_fields”: [“legal_name”,“acct_id”,“mrn”,“address”]
  },
  “proof_plan”: {
    “proof_type”: “sig_vp|sd_vp|zk_predicate”,
    “cryptosuite”: “suite_id”,
    “challenge_binding”: true
  },
  “mode_plan”: {
    “mode”: “centralized|ssi|hybrid|offline_capable”,
    “mode_profile_id”: “profile://gaming_competitive_v2”
  },
  “freshness_plan”: {
    “status_mechanism”: “status_list|accumulator|merkle”,
    “min_epoch”: 4102,
    “max_staleness_seconds”: 86400,
    “grace_seconds”: 3600
  },
  “enforcement_plan”: {
    “adapter”: “gaming_adapter|healthcare_adapter|enterprise_adapter”,
    “on_success”: [“ApplyGate(ALLOW_MATCHMAKING)”],
    “on_fail”: [“ApplyGate(DENY)”],
    “token_issuance”: {“enabled”: true, “ttl_seconds”: 600}
  },
  “signatures”: {
    “vpo_signature”: “Sig(policy_engine_key, H(core_fields))”
  }
}
```

The VPO signature covers at least the relying_app_id, the required_condition, the allowed_fields list, and the freshness_plan, and includes a hash of the VRQ that incorporates the challenge value. This prevents replay and context substitution.

The content delivery module 420 is responsible for the efficient retrieval and delivery of the 3D model of the avatar and the associated assets from the content database 410 to the SDK module 430. The content delivery module 420 facilitates seamless communication between the content database 410 and the SDK module 430, ensuring that the necessary avatar and asset data are readily available for customization and rendering within the various 3D rendering platforms. Specifically, the content delivery module 420 processes the incoming request from the API module 440, queries the content database 410, and retrieves the relevant data. The integration of the content delivery module 420 within the present system 400 helps to maintain a seamless and efficient workflow between the content database 410, the API module 440, and the SDK module 430. By working in tandem with these other components, the content delivery module 420 allows users to access and customize their avatars and assets with minimal delays, regardless of their specific 3D rendering platform 10 or the user device 300.

In addition to its primary function of fetching and delivering the 3D model of the avatar and the assets, the content delivery module 420 may also serve a broader role in optimizing the performance and user experience within the system 400. The content delivery module 420 may employ various caching mechanisms and strategies to minimize latency, reduce bandwidth consumption, and ensure the timely delivery of content. For instance, to improve performance and reduce response times, the content delivery module 420 may incorporate a caching mechanism which stores frequently requested avatar models and assets in a cache, thereby minimizing the need for repetitive database queries and speeding up content delivery. To handle varying levels of demand and ensure optimal performance, the content delivery module 420 may include a load balancing component, which distributes incoming requests across multiple instances of the content delivery module 420, ensuring that no single instance becomes overwhelmed with traffic. To protect the integrity of the content and prevent unauthorized access, the content delivery module 420 may also incorporate security and authentication mechanisms, which validate incoming requests, verify user credentials, and apply encryption to the content as necessary.

The content delivery module 420 may also leverage advanced algorithms and techniques to prioritize and manage the delivery of assets based on factors such as network conditions, user location, and device capabilities. This ensures that the user experience remains consistent and responsive, even in situations where network connectivity or device performance may be less than optimal. In an embodiment, the content delivery module 420 utilizes a Content Delivery Network (CDN) to further optimize the retrieval and distribution of the 3D model of the avatar and the associated assets to user devices 300 across various 3D rendering platforms 10. A CDN is a globally distributed network of servers that work together to provide fast and efficient delivery of content to users based on their geographical location and proximity to the CDN servers. By leveraging the geographical distribution of CDN servers, the content delivery module 420 can deliver the 3D model of the avatar and the assets from a server that is closer to the user's location, resulting in reduced latency and faster response times. The CDN may further improve reliability by distributing content across multiple servers and locations, ensuring that the 3D model of the avatar and the assets remain available and accessible even in the event of server outages or network disruptions. Further, as the number of users and the demand for content increases, the CDN can easily scale to accommodate the growing traffic without compromising the performance of the content delivery module 420, and thereby the overall system 400.

In operation of the present system 400, when the user initiates a customization request, the SDK module 430 communicates with the API module 440, sending a first request for the 3D model of the avatar and required first assets. Herein, the term “first assets” refers to the initial set of digital items, features, or components associated with a user's avatar within the content database 410. That is, the first assets are the pre-existing assets available to a user when they first create or customize their avatar within a specific 3D rendering platform 10. These first assets are directly linked to the 3D model of the avatar and may include various customization options such as clothing, facial features, hair textures and colors, accessories, and more. Further, the term “first request” refers to the initial communication initiated by the SDK module 430 to the API module 440 when the user wishes to access and utilize these first assets for avatar customization. Upon receiving the first request from the SDK module 430, the API module 440 forwards the first request to the content delivery module 420. The content delivery module 420 is responsible for fetching the requested 3D model of the avatar and the first assets from the content database 410. The content delivery module 420 efficiently retrieves the requested content, leveraging caching mechanisms and the CDN, if required, to ensure optimal performance and quick response times. Once the content delivery module 420 has fetched the 3D model of the avatar and the relevant first assets from the content database 410, the content delivery module 420 delivers this data back to the SDK module 430. The SDK module 430 then integrates the fetched content with the in-engine avatar customization module 14, enabling the user to seamlessly customize their avatar in real-time within the 3D rendering platform 10. This streamlined process ensures that users can effortlessly personalize their avatars across multiple 3D rendering platforms 10, fostering a more engaging and immersive experience for users as they interact within various virtual environments.

In some scenarios, the user may acquire new customization assets, referred to as “second assets,” while using the 3D rendering platforms 10. These second assets may include additional clothing, accessories, or other personalization elements that the user obtains through in-platform achievements, purchases, or other means. To ensure that these newly acquired assets are accessible for future avatar customization, the system 400 allows to save these second assets in the content database 410. For this purpose, the SDK module 430 is further configured to fetch one or more second assets utilized by the user for customization of the avatar as available in and by implementation of the said corresponding in-engine avatar customization module 14 at the runtime. That is, the SDK module 430, integrated with the in-engine avatar customization module 14 of the 3D rendering platform 10, detects the user's utilization of the newly acquired second assets at runtime. The SDK module 430 then retrieves these second assets from the in-engine avatar customization module 14. Also, the API module 440 is further configured to receive a second request from the SDK module 430 for the said one or more second assets for storage in the content database 410. That is, once the second assets are fetched, the SDK module 430 sends a second request to the API module 440. This second request may contain the acquired second assets and may indicate that they should be stored in the content database 410. Further, the content delivery module 420 is further configured to fetch the said one or more second assets from the SDK module 430 in response to the said second request at the API module 440. That is, in response to the second request received at the API module 440, the content delivery module 420 retrieves the second assets from the SDK module 430. This ensures that the content delivery module 420 has access to the new assets for subsequent storage and distribution. Furthermore, the content database 410 is configured to store the said one or more second assets therein. That is, after retrieving the second assets from the SDK module 430, the content delivery module 420 stores them in the content database 410. This allows users to access and utilize the new assets for future avatar customization across the multiple 3D rendering platforms 10. By implementing this process, the system 400 ensures that users' newly acquired assets (i.e., second assets) are saved to be readily available for use in future avatar customization sessions.

According to one or more embodiments, as illustrated in FIG. 4, the system 400 may further include a user account module 450 for recording ownership of the avatar and associated assets for the user. Herein, the user account module 450 records the ownership of the user's 3D avatar model, the initial first assets, and any additional second assets. This ensures that the system 400 accurately tracks digital belongings of the user and enables a smooth and secure user experience across the multiple 3D rendering platforms 10. For this purpose, when a user may first register in the system 400, the user account module 450 creates a unique account for such user, which stores the user's avatar, first assets, and any subsequently acquired second assets. The user account module 450, in conjunction with other components of the system 400 such as the content database 410, ensures that user has access to their avatars and associated assets across the multiple 3D rendering platforms 10. This feature enables a consistent and personalized user experience, regardless of the 3D rendering platform 10 being used.

In an embodiment, the user account module 450 is configured to implement a distributed ledger 452 for recording the ownership of the 3D model of the avatar, the one or more first assets and the one or more second assets for the user. That is, the user account module 450 may implement the distributed ledger 452, such as a blockchain, to provide a secure and transparent method of tracking asset ownership. It may be contemplated by a person skilled in the art that these records may be stored in the distributed ledger 452 to provide a clear and immutable history of each user's digital belongings. This technology ensures that the ownership records are tamper-resistant and easily verifiable, enhancing trust in the system 400. The distributed ledger 452 implemented by the user account module 450 further enables secure and transparent asset transfers between users, such as trading or gifting avatar customization items. Thereby, the user account module 450 is able to track these transactions and updates the ownership records accordingly.

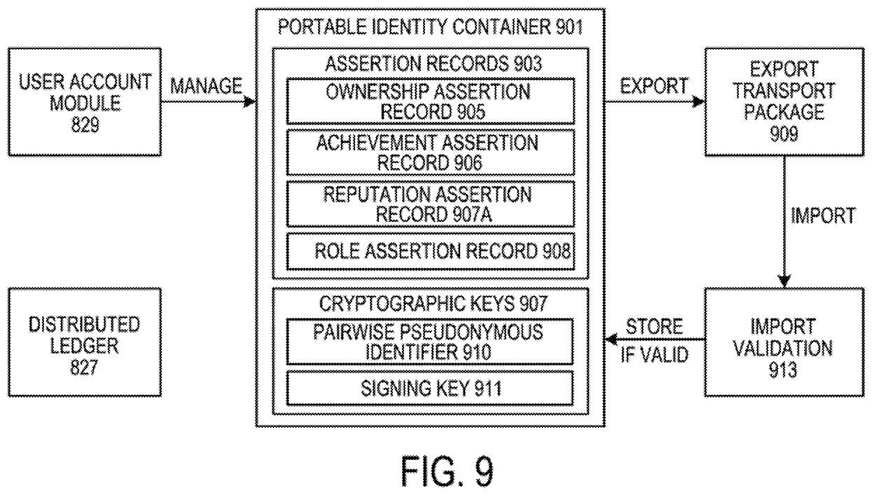

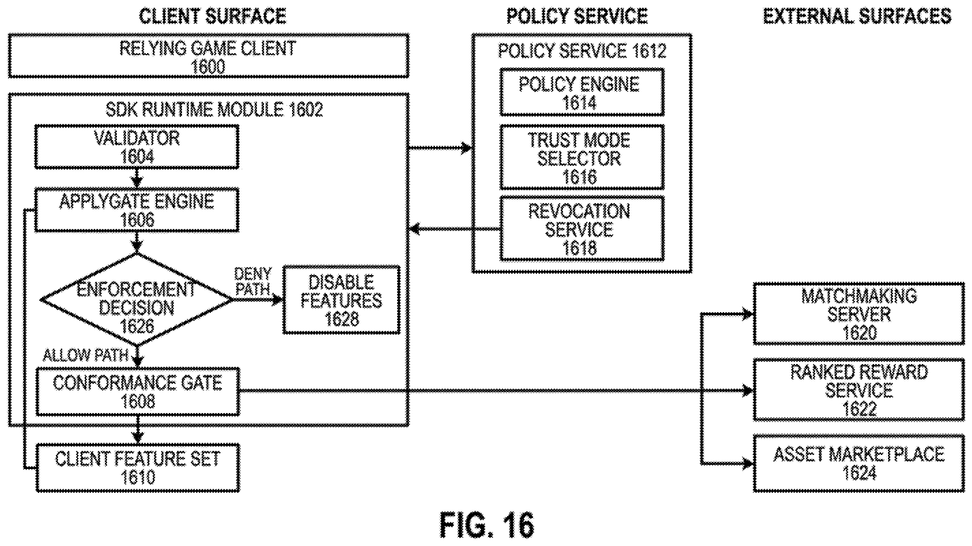

Expanding on this functionality, and as illustrated in FIG. 9, the user account module 450 is further configured to manage a Portable Identity Container (PIC) associated with the user. The PIC is a portable, exportable data structure that stores assertion records, cryptographic keys (including per-relying-app keys as shown in FIG. 16), and policy metadata. An assertion record is a verifiable claim representing at least one of ownership, entitlement, achievement, reputation, role, or trust status. The distributed ledger 452 serves as the persistent, tamper-resistant source of truth for ownership-related assertion records stored in the PIC. The user account module 450 may further interface with a proof generator to create a Verifiable Presentation (VP) from one or more assertion records in the PIC to prove a condition to a relying application.

Also, as illustrated in FIG. 4, the system 400 may further include a multi-application caching module 460 for deleting duplicate entries of the 3D model of the avatar and associated assets between the multiple 3D rendering platforms 10 in the user device 300. That is, the system 400 may also incorporate the multi-application caching module 460 designed to optimize the storage and management of the 3D avatar model and its associated assets in the user device 300 when accessed across multiple 3D rendering platforms 10. For this purpose, the multi-application caching module 460 may continuously monitor the cache storage on the user device 300, identifying instances where the 3D avatar model and associated assets are being duplicated across different 3D rendering platforms 10. Upon detecting duplicate entries, the multi-application caching module 460 consolidates them into a single, unified cache entry. This process ensures that one instance, and optionally only one instance, of the 3D avatar model and its related assets are stored on the user device 300, regardless of the number of the 3D rendering platforms 10 being used. Further, the multi-application caching module 460 synchronizes the unified cache entry with each 3D rendering platform 10 to maintain consistency across the 3D rendering platforms 10, and thus ensures that any changes or updates made to the avatar or assets in one of the 3D rendering platforms 10 are reflected across all other platforms, providing a seamless user experience. Finally, the multi-application caching module 460 also efficiently manages the cache storage by regularly checking for outdated or unused avatar models and assets, and removing them as necessary. By eliminating duplicate entries, the multi-application caching module 460 conserves storage space and enhances the overall performance of the user device 300.

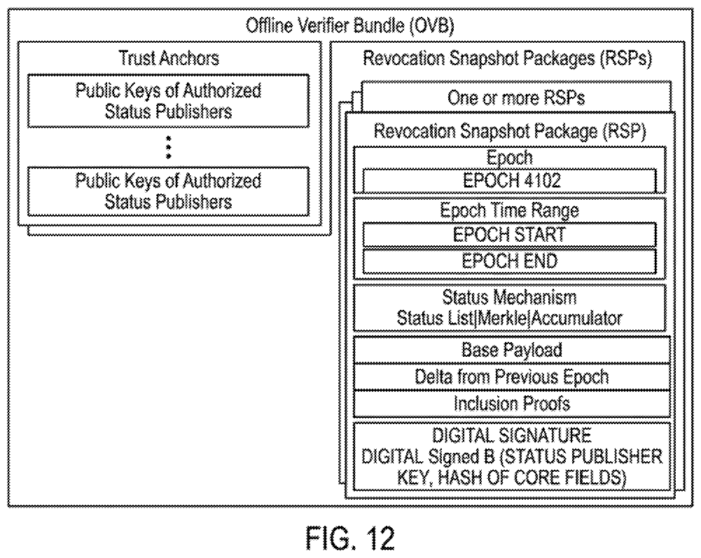

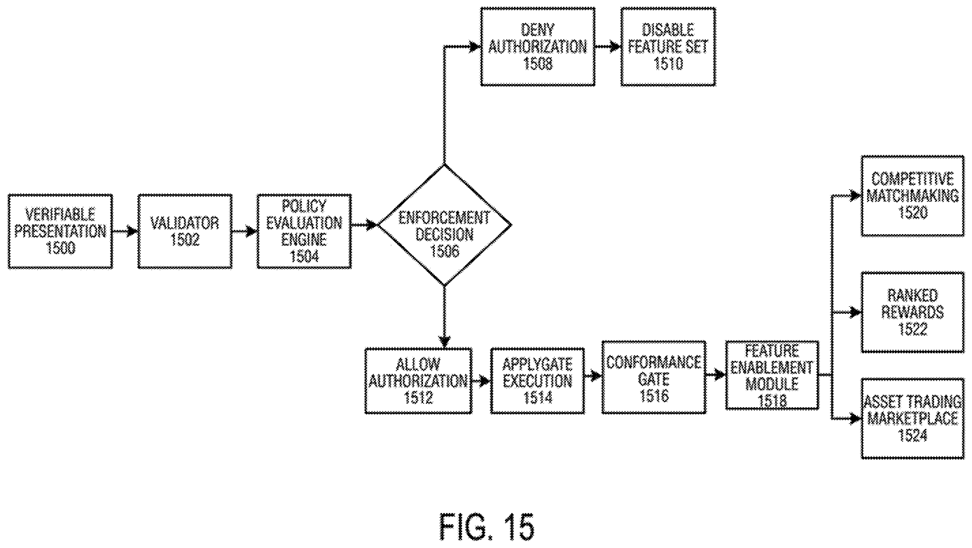

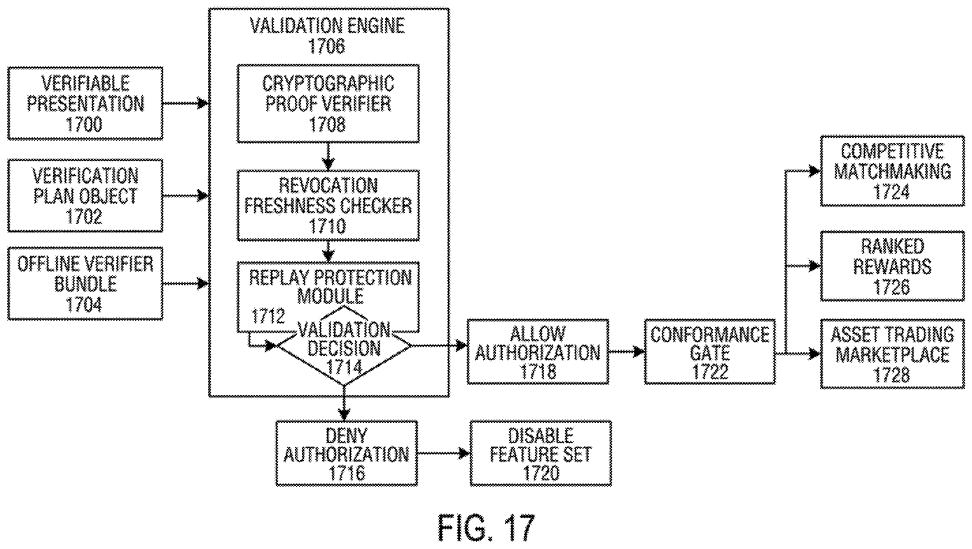

The system 400 can optionally provide for deterministic and auditably reproducible trust-mode selection, using techniques described in connection with FIG. 11. The system 400 can furthermore optionally support offline validation of a Verifiable Presentation, using techniques illustrated in FIG. 12 and FIG. 13. The system 400 can additionally be configured to initiate a verification process when a relying application requires proof of a condition about a user, using techniques illustrated in FIG. 8 and FIG. 14. In gaming embodiments, as illustrated in FIG. 15, the system 400 may implement a unified gamer identity interoperability layer. To reduce cross-service tracking while preserving portability, the system 400 can derive pairwise identifiers and keys, as illustrated in FIG. 16. As illustrated in FIG. 17, the system 400 may also operate in a hybrid mode where centralized services publish status signals and RSPs, while a subject presents user-held proofs.

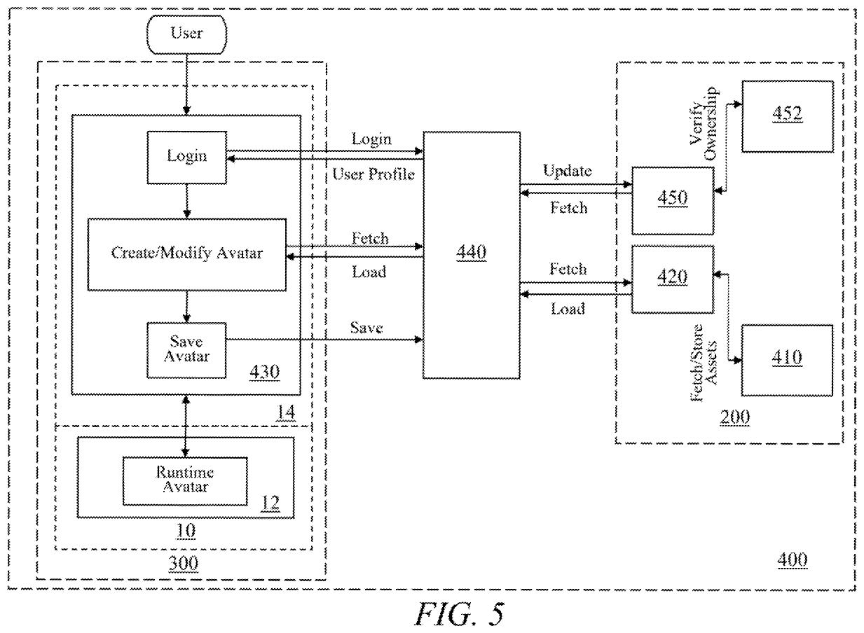

Referring to FIG. 5, illustrated is a schematic diagram depicting process flow for implementation of the present system 400 for managing the avatar for the user for use in the multiple 3D rendering platforms 10. The user initiates the process by logging in to the SDK module 430, which is integrated into the in-engine avatar customization module 14 of each 3D rendering platform 10. The login request is sent to the user account module 450 via the API module 440. The user account module 450 verifies the user's credentials and grants them access to their avatar and associated assets, via the API module 440. The user account module 450 incorporates the distributed ledger 452 to record and manage the ownership of the avatar and associated assets. Upon successful login, the user is presented with options to create a new avatar or modify an existing one using the in-engine avatar customization module 14. The user may customize their avatar by choosing from the available assets, such as clothing items, facial features, hair textures, and accessories. Once the user is satisfied with their avatar's appearance, they can save the changes by selecting a save option within the SDK module 430. The SDK module 430 then sends a request to the API module 440, which in turn communicates with the content delivery module 420 to fetch the updated 3D model of the avatar and the selected assets. The content delivery module retrieves the updated 3D avatar model and assets from the content database 410 and delivers them to the SDK module 430. The content database 410 then stores the 3D avatar model and its associated assets for future use. As the user interacts with different 3D rendering platforms 10, they can continue to customize their avatar using the in-engine avatar customization module 14 and the available assets. Any changes made during these sessions are saved and synchronized across platforms through the SDK module 430.

In an embodiment, as illustrated in FIG. 5, the content database 410 and the content delivery module 420 are executed in a server (such as, the server 200). This setup allows for centralized storage and management of the 3D models of avatars, along with their associated first and second assets. The server 200 provides the necessary computational resources and network connectivity to manage the content database 410 effectively and to deliver assets to the SDK module 430 via the content delivery module 420. By executing the content database 410 and the content delivery module 420 on the server 200, the system 400 may efficiently handle multiple requests from different user devices 300 simultaneously, maintaining its performance and responsiveness. The server-based architecture also facilitates easy updates and maintenance for the system 400, as any changes or improvements to the content database 410 or the content delivery module 420 may be implemented on the server-side without requiring updates on the individual user devices 300.

In a specific embodiment, the server 200 is a cloud-based server. Such cloud-based server offers scalability, flexibility, and reliability to efficiently manage the storage and delivery of avatars and associated assets. By utilizing the cloud-based server 200, the content database 410 may store a vast amount of data, including 3D models of avatars, first assets, and second assets, and easily scale its storage capacity as the user base grows. This allows the system 400 to accommodate increasing amounts of data without compromising performance or availability. Further by operating in the cloud-based server 200, the content delivery module 420 may efficiently serve requests from multiple users simultaneously while maintaining low latency and high throughput. In some examples, the content delivery module 420 may be configured to implement an edge server based on a location and/or a bandwidth of the user device 300 for faster delivery to and fetching from the SDK module 430. This cloud-based architecture ensures that the system 400 may effectively manage and deliver avatar data to users across multiple 3D rendering platforms while maintaining optimal performance, security, and scalability.

In an alternate embodiment, the content database 410 and the content delivery module 420 are executed in the user device 300 (not illustrated). With this configuration, the user device takes on the responsibility of locally managing the content database 410 and delivering assets via the content delivery module 420. It may be understood that when the content database 410 and the content delivery module 420 are executed in the user device 300, the system 400 allows for a more decentralized approach to storing and managing the 3D models of avatars, along with their associated assets. By executing the content database 410 and the content delivery module 420 on the user device 300, the system 400 may be able to reduce latency and dependence on server resources, as the data is fetched locally instead of requiring communication with a remote server. Thereby, this approach can improve the responsiveness and performance of the system 400 on the user's end.

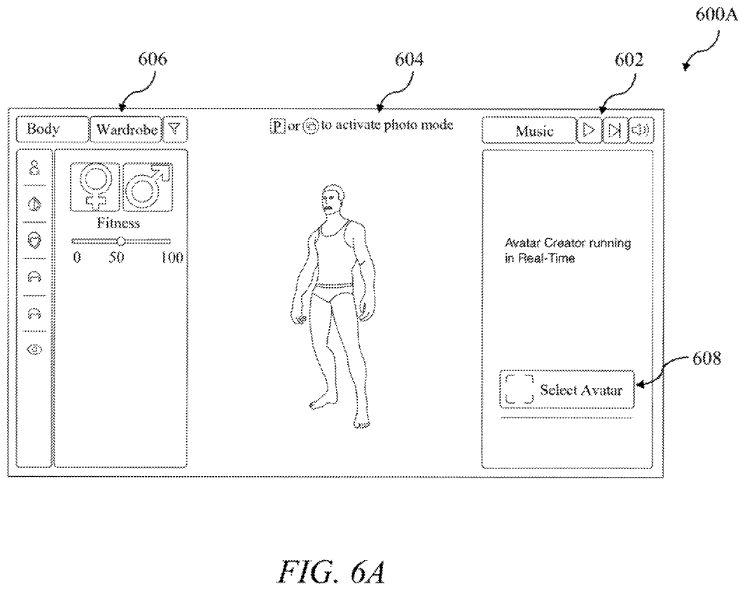

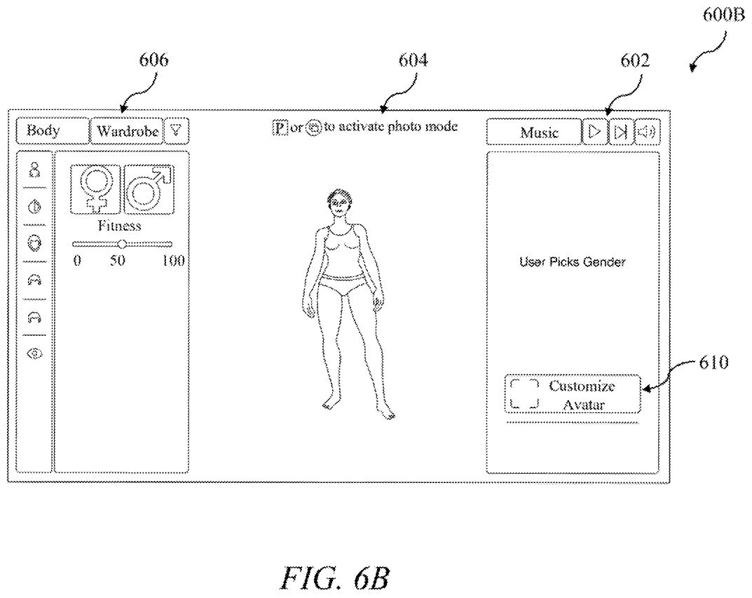

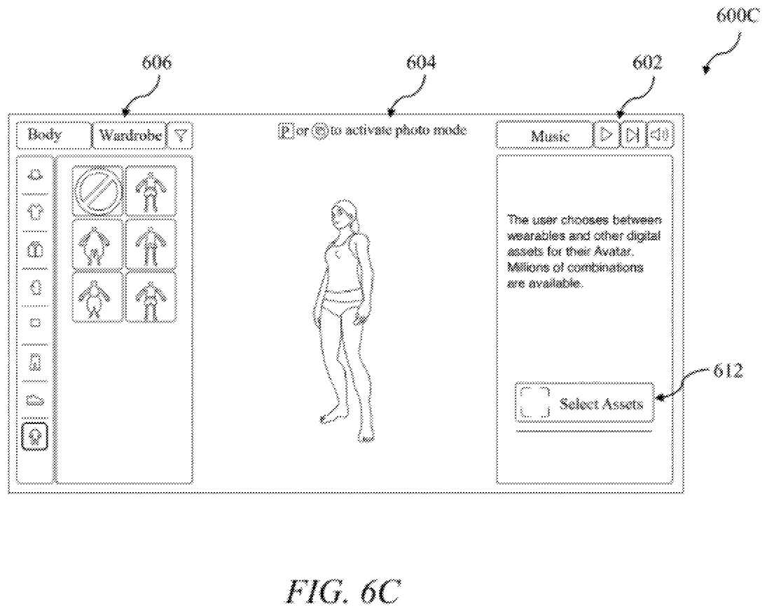

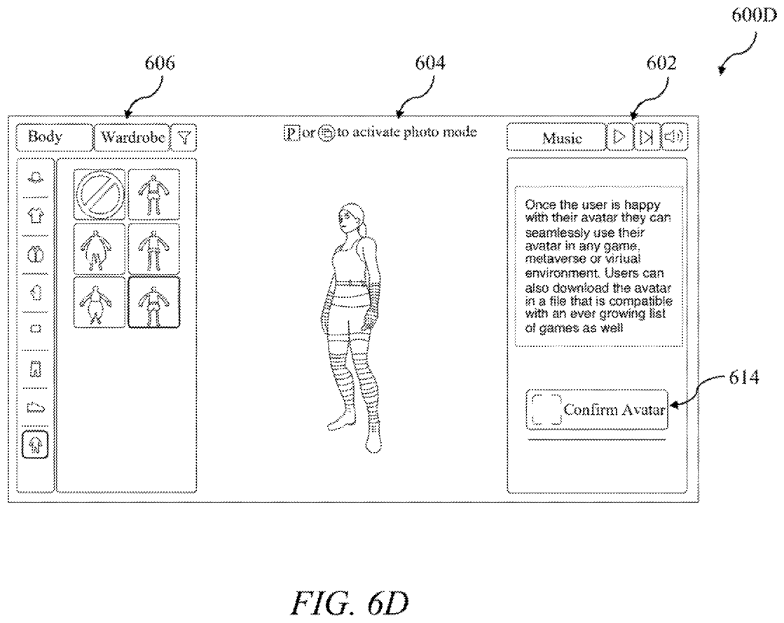

Referring to FIGS. 6A-6D , illustrated are example depictions of various interfaces which may be implemented to allow the user to manage the avatar as per embodiments of the present disclosure. In particular, FIG. 6A depicts a first interface 600A which provides a dynamic and interactive environment for users to design and customize their avatars in real-time. As users make changes to their avatars, the first interface 600A immediately reflects the alterations, allowing them to visualize their creations without delay. This instant feedback enhances the user experience and promotes a more intuitive and enjoyable avatar design process. In particular, the first interface 600A provides a music panel 602 which allows the users to add music assets to their avatar. The first interface 600A also provides a photo panel 604 which allows the users to add a photo or click a photo (from an associated camera device, like webcam) to customize the avatar accordingly. The first interface 600A further provides a profile panel 606 which allows the users to change profile of the avatar, like selecting gender, changing body type, changing fitness level, adding wardrobe elements, etc. The first interface 600A further provides a Select Avatar button 608 for the user to select the displayed avatar. It may be appreciated that the illustrated first interface 600A is an example only and shall not be construed as limiting to the present disclosure in any manner.

FIG. 6B depicts a second interface 600B which enables users to choose the gender of their avatar at the initial stage of the creation process. This choice sets the foundation for the avatar's appearance and informs the subsequent customization options available. By offering a user-friendly interface for gender selection, the system 400 ensures that users may easily create avatars that align with their preferences and identity. The second interface 600B provides a Customize Avatar button 610 for the user to customize the displayed avatar. As soon as the gender selection or any other action related to change in the body profile of the avatar may be completed by the user, the corresponding avatar image may change in the second interface 600B to reflect such action of the user.

FIG. 6C depicts a third interface 600C which allows users to personalize their avatars by selecting from a wide variety of assets including clothing, accessories, hairstyles, and other customizable elements. With numerous possible combinations, users can create a unique avatar that reflects their style and personality. The third interface 600C provides a Select Assets button 612 for the user to select the assets for the avatar. The third interface 600C fosters creativity and self-expression, enhancing the overall avatar creation experience.

FIG. 6D depicts a fourth interface 600D which enables the user to seamlessly use their avatar in the multiple 3D rendering platforms 10. The fourth interface 600D provides a Confirm Avatar button 614 for the user to finalize the displayed avatar. That is, upon finalizing their avatar design, the user can take advantage of the SDK module 430 to effortlessly integrate their avatar into various 3D rendering platforms 10, including games, metaverses, and virtual environments. Additionally, the fourth interface 600D may offer the users the option to download their avatar as an FBX (Filmbox), GLB (GL Binary), GLTF (Graphics Library Transmission Forma), or VRM (Virtual Reality Modeling) file, ensuring compatibility with a wide range of gaming platforms and applications. Thus, the fourth interface 600D empowers users to fully enjoy and utilize their custom avatars across multiple digital environments.

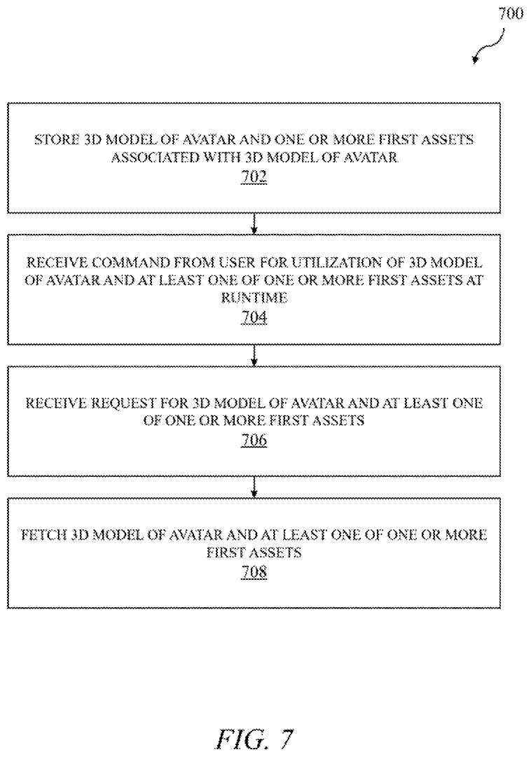

The present disclosure further provides a method for managing an avatar for a user for use in the multiple 3D rendering platforms 10. Referring now to FIG. 7, illustrated is a flowchart for the said method (as represented by reference numeral 700) listing steps involved therein. Various embodiments and variants disclosed above with respect to the system 400 for managing the avatar apply mutatis mutandis to the present method 700. Thus, the details as described above with respect to specific elements have not been repeated herein for brevity of the present disclosure. Also, it may be contemplated that steps (as described hereinafter) for the method 700 are illustrative and other alternatives can also be provided where one or more steps are added, one or more steps are removed, or one or more steps are provided in a different sequence without departing from the spirit and the scope of the present disclosure.

At step 702, the method 700 includes storing, in the content database, the 3D model of the avatar and the one or more first assets associated with the 3D model of the avatar, as available with the user. This step 702 involves creating a storage system for the user's avatar and its associated assets, ensuring they are readily accessible for future use. At step 704, the method 700 includes receiving a command from the user for utilization, via the SDK module 430 integrated with the in-engine avatar customization module 14 of each one of the multiple 3D rendering platforms 10, of the said 3D model of the avatar and at least one of the said one or more first assets compatible with the corresponding in-engine avatar customization module 14 at the runtime, to customize the avatar. This step 704 involves the user interacting with the SDK module 430 to request the customization of their avatar using the available assets in real-time, which is made possible by integrating the SDK module 430 with the in-engine avatar customization module 14. At step 706, the method 700 includes receiving the first request from the SDK module 430 for the said 3D model of the avatar and the said at least one of the one or more first assets. That is, the first request is received from the SDK module 430 to access the user's avatar and its associated assets. At step 708, the method 700 includes fetching the said 3D model of the avatar and the said at least one of the one or more first assets from the content database 410 in response to the said first request, for delivery to the SDK module 430. Herein, the API module 440 retrieves the requested avatar and assets from the content database 410 and delivers them to the SDK module 430 for use in customizing the avatar.

In one or more embodiments, the method 700 also includes fetching the one or more second assets utilized by the user for customization of the avatar as available in and by implementation of the said corresponding in-engine avatar customization module 14. This step involves accessing additional assets that the user has acquired or created within the 3D rendering platforms. The method 700 further includes receiving the second request from the SDK module 430 for the said one or more second assets for storage in the content database 410. Herein, the API module 440 receives the second request to store the new assets in the content database 410 for future use. The method 700 further includes fetching the said one or more second assets from the SDK module 430 in response to the said second request. Herein, the API module 440 retrieves the new assets from the SDK module 430. The method 700 further includes storing the said one or more second assets in the content database 410. That is, the new assets are stored in the content database 410 alongside the user's avatar and first assets.

In one or more embodiments, the method 700 further includes recording ownership of the 3D model of the avatar, the one or more first assets, and the one or more second assets for the user. This step utilizes the user account module 450 to ensure that users maintain ownership of their avatars and associated assets. For this purpose, the method 700 further includes implementing the distributed ledger 452 for recording the ownership of the 3D model of the avatar, the one or more first assets, and the one or more second assets for the user. The distributed ledger 452, such as a blockchain, is used to record ownership information securely and transparently.

In one or more embodiments, the method 700 further includes deleting duplicate entries of the 3D model of the avatar, the one or more first assets, and the one or more second assets between the multiple 3D rendering platforms 10 in the user device 300. This step optimizes storage by eliminating redundant data across different 3D rendering platforms 10 in the user device 300, for efficient storage.

In an embodiment, the method 700 further includes executing the content database 410 and the content delivery module 420 in the server 200. This ensures that the content database 410 and the content delivery module 420 are hosted on the server 200 for optimal performance and accessibility. In another embodiment, the method 700 further includes executing the content database 410 and the content delivery module 420 in the user device 300. That is, the content database 410 and content delivery module 420 may alternatively be executed within the user device 300, providing a different implementation option that can cater to specific user needs or requirements. This approach may offer advantages such as reduced latency or increased privacy, depending on the specific use case and user preferences.

The present disclosure provides the system 400 and the method 700 for creating and customizing avatars to a granular level that can be used across various games, metaverses, or any other real-time 3D rendered environment. The present disclosure utilizes several technologies, including 3D game engines, in-engine runtime avatar customization systems, remote addressable asset systems, cloud storage, content delivery network, user account databases, multi-application caching systems, and blockchain technology for achieving the said purpose in an efficient manner. The present disclosure allows users to change items while in runtime, enabling users to pick up assets from one game or metaverse and use them in another. Specifically, the present disclosure provides an SDK that allows developers to deploy avatars, wearables, digital items, music, and video into any game, metaverse, or 3D application, and thus provides a seamless experience for the user, allowing them to easily customize and modify their avatars, and enables users to interchange their avatars and assets between games and metaverses as desired. Ownership of assets is stored using blockchain technology, and assets can be added to the catalog at any time.

The present disclosure offers several advantages over existing solutions. Firstly, the system 400 and the method 700 provide a seamless experience for the user, allowing them to easily interchange their avatars and assets between games and metaverses without the need for manual import and export processes. This saves time and effort for the user, enhancing their overall experience. Secondly, the system 400 and the method 700 offer a more efficient way to manage avatar ownership and associated assets using the distributed ledger 452, which ensures a transparent and decentralized method for managing asset ownership. This can help to prevent disputes and provide users with greater control over their avatars and assets. Lastly, the multi-application caching module 460 helps to optimize resource usage by deleting duplicate entries of avatar and asset data between multiple real-time 3D rendering platforms in the user device 300. This can improve the performance of the system 400 and reduce the amount of storage space used on the user device 300. Overall, the present disclosure provides a more seamless and efficient way to manage avatars and their associated assets for use across multiple real-time 3D rendering platforms 10, addressing the limitations of existing solutions and improving the user experience.

FIG. 8 illustrates a system architecture overview of the interoperable verification system, depicting the flow from a verification request to the generation of a verification plan object. The system includes a relying application 800, a verification policy engine 812, and a verification plan object 822.

The relying application 800 initiates the verification process by generating a verification request 802. The verification request 802 comprises several components including a relying app ID 804 that identifies the requesting application, a required condition 806 that specifies the condition to be verified, context risk tags 808 that provide contextual information about the risk level, and a challenge nonce 810 that provides replay protection.

The verification policy engine 812 receives the verification request 802 and processes it through several internal components. The verification policy engine 812 includes a precedence rule table 814 that stores deterministic rules for mapping request parameters to verification modes. A policy matcher 816 receives input from the precedence rule table 814 and evaluates the verification request 802 against stored policies. The policy matcher 816 forwards its output to a VPO generator 818, which constructs the verification plan object based on the matched policies. A cryptographic binding module 820 receives the output from the VPO generator 818 and cryptographically binds the generated plan to the original request context to prevent replay and context substitution attacks.

The verification plan object 822 is the output of the verification policy engine 812 and comprises several specification components. A disclosure plan 824 defines the permitted fields for disclosure to enforce policy-minimized disclosure. A proof type 826 identifies the cryptographic proof type for the verification. A trust mode 828 specifies the selected verification mode determined by the precedence rule table 814. Freshness requirements 830 specify constraints including at least one of a minimum epoch or a maximum staleness for revocation status. Enforcement actions 832 define the actions to be taken based on verification success or failure.

The cryptographic binding module 820 produces a bound plan package 834, which represents the verification plan object 822 cryptographically bound to the verification request 802 context. This binding ensures the integrity and authenticity of the verification plan throughout the verification process, preventing unauthorized modification or replay of the verification plan object 822.

FIG. 9 illustrates the internal structure of a Portable Identity Container (PIC) 901, an export transport package format, and import validation, in accordance with one or more example embodiments of the present disclosure. The system depicted shows the relationship between a user account module 829, a distributed ledger 827, and the portable identity container 901, along with the mechanisms for exporting and importing identity data.

The user account module 829 is configured to manage the portable identity container 901. The portable identity container 901 is a portable, exportable data structure that stores multiple types of records and cryptographic materials associated with a user. Within the portable identity container 901, assertion records 903 are stored, which include several categories of verifiable claims. The ownership assertion record 905 represents claims related to ownership of digital assets, such as the 3D model of the avatar and associated assets. The achievement assertion record 906 stores claims related to user achievements across platforms. The reputation assertion record 907A contains claims representing reputation metrics or trust scores that may be aggregated from multiple sources. The role assertion record 908 stores claims related to roles or permissions assigned to the user within various platforms.

The portable identity container 901 also stores cryptographic keys 907, which include a pairwise pseudonymous identifier 910 and a signing key 911. The pairwise pseudonymous identifier 910 is derived uniquely per relying application to reduce cross-service correlation and tracking, thereby enhancing user privacy. The signing key 911 is used for cryptographic operations such as generating verifiable presentations from the assertion records 903.

The distributed ledger 827 interfaces with the portable identity container 901 and serves as a persistent, tamper-resistant source of truth for ownership-related assertion records stored within the container. This ensures that ownership claims can be independently verified against an immutable record.

The portable identity container 901 supports an export function that generates an export transport package 909. The export transport package 909 contains the assertion records 903 and associated data in a format suitable for transfer to another system or platform. This enables users to migrate their identity data between different implementations of the system 400. The export transport package 909 can be imported into another instance of the system, where import validation 913 is performed. The import validation 913 verifies the integrity and authenticity of the imported data by checking cryptographic signatures and validating the structure of the assertion records. If the validation is successful, the data is stored in the receiving portable identity container 901, enabling seamless portability of the user's digital identity across platforms.

FIG. 10 illustrates the flow from a Verification Request (VRQ) to VPO generation, binding, and proof generation, in accordance with one or more example embodiments of the present disclosure. The diagram depicts the interaction between a relying 3D rendering platform represented by the software development kit module 430, an API module 440 functioning as a verification policy engine, and a subject/proof generator 1010, with communications flowing to and from a user device 316.

The software development kit module 430 includes a validator 432 and initiates the verification process by generating a VRQ 1002. The VRQ 1002 contains several fields including a relying app ID, a required condition, context/risk tags, and a challenge nonce. The VRQ 1002 is transmitted via VRQ transmission 1012 to the API module 440.

The API module 440 operates as a verification policy engine and performs several functions upon receiving the VRQ 1002. The API module 440 executes VPO generation, applies precedence rules, and performs cryptographic binding 1030. The API module 440 generates a VPO 1004 in response to a VPO generation request 1016. The VPO 1004 comprises multiple plan components including a disclosure plan, a proof plan, a trust mode plan, a freshness plan, and an enforcement plan. The VPO 1004 also includes a relying app ID and a VRQ hash that cryptographically binds the VPO 1004 to the original VRQ 1002. The VPO 1004 is transmitted via VPO transmission 1014 back toward the software development kit module 430.

The subject/proof generator 1010 receives information via proof generation flow 1018 and performs proof generation operations. The subject/proof generator 1010 generates cryptographic proofs based on the requirements specified in the VPO 1004. The output of the subject/proof generator 1010 is a VP 1006 containing a verifiable presentation 523, which is transmitted via verifiable presentation output 1020.

Communication channel 1022 represents the bidirectional data flow between the various components of the system. The user device 316 interfaces with both the software development kit module 430 and the subject/proof generator 1010, enabling the user to participate in the verification process. The cryptographic binding 1030 ensures that the VPO 1004 is securely linked to the original VRQ 1002, preventing replay attacks and context substitution.

The system 400 can provide for deterministic and auditably reproducible trust-mode selection. The API module 440 or a trust-mode selector applies a stored precedence rule table, as illustrated in FIG. 11, to map inputs from the VRQ context (such as partner policy, jurisdiction, risk classification, and network state) to a selected verification mode. This prevents arbitrary selection. An example precedence rule table may comprise the following logic:
Priority 1: If a partner policy requires a centralized mode, select CENTRALIZED, overriding all other conditions.
Priority 2: If a jurisdiction requires local logging or compliance, select CENTRALIZED or HYBRID mode.
Priority 3: If the network state is offline and offline validation is permitted, select OFFLINE_CAPABLE mode, which may require a tight validity window and strict freshness.
Priority 4: If the risk classification is high (e.g., competitive matchmaking), select HYBRID mode.
Priority 5: If the risk is medium, select Self-Sovereign (SSI) or HYBRID mode.
Priority 6: If the risk is low, select SSI mode for minimal friction.
Priority 7: Default to SSI mode as a fallback. The validator in the SDK module 430 denies authorization if the verification mode used is inconsistent with the outcome of this rule table.

FIG. 11 illustrates a deterministic trust-mode selection process using a precedence rule table and mode profiles, in accordance with one or more example embodiments of the present disclosure. The system depicted in FIG. 11 shows the interaction between VRQ context inputs 1102, an API module 440 functioning as a trust-mode selector, and various verification modes that may be selected based on the context.

The VRQ context inputs 1102 comprise several input parameters including partner policy, jurisdiction, risk classification, and network state. These inputs are provided to the API module 440, which serves as the trust-mode selector for the system. Within the API module 440, a stored precedence rule table 1104 is maintained, which contains priority rules 1-7 that define the mapping logic for mode selection. The stored precedence rule table 1104 includes a match context function that evaluates the incoming VRQ context inputs 1102 against the priority rules, followed by a select mode function that determines the appropriate verification mode based on the matched context.

The API module 440 is connected to four possible verification modes that may be selected as outputs. These modes include centralized mode 1106, hybrid mode 1108, offline capable mode 1110, and self-sovereign mode 1112. The selection of one of these modes is determined by applying the stored precedence rule table 1104 to the VRQ context inputs 1102 in a deterministic manner. The centralized mode 1106 is selected when partner policy mandates centralized verification or when jurisdictional compliance specifies local logging. The hybrid mode 1108 is selected for high-risk scenarios such as competitive matchmaking or when a combination of centralized and decentralized verification is appropriate. The offline capable mode 1110 is selected when the network state indicates offline operation and offline validation is permitted, requiring strict freshness constraints. The self-sovereign mode 1112 is selected for low-risk scenarios or as a default fallback when no higher-priority conditions are met.

The selected mode is then provided to a software development kit module 430, which contains a validator 1114. The validator 1114 is configured to enforce the selected mode and produce an authorization decision as output. The validator 1114 ensures that the verification process adheres to the mode selected by the API module 440 based on the precedence rules, denying authorization if the verification mode used is inconsistent with the outcome of the rule table. This deterministic approach ensures that trust-mode selection is auditably reproducible and prevents arbitrary or inconsistent mode selection across verification requests.

### Offline Validation Framework (FIG. 12, FIG. 13)

As illustrated in FIG. 12 and FIG. 13, the system 400 further supports offline validation of a Verifiable Presentation. For this purpose, the system includes an Offline Verifier Bundle (OVB) stored by, or accessible to, the relying application. As shown in FIG. 12, the OVB comprises one or more trust anchors (e.g., public keys of authorized status publishers) and one or more Revocation Snapshot Packages (RSPs). Each RSP is a data structure that is digitally signed by an authorized status publisher, is associated with a respective epoch, and may include deltas from a previous epoch and inclusion proofs. An illustrative, non-limiting example of an RSP schema is as follows:

```
{
  “rsp_version”: “1.0”,
  “issuer_id”: “issuer://publisher_or_registry”,
  “epoch”: 4102,
  “epoch_start”: “2025-12-01T00:00:00Z”,
  “epoch_end”: “2025-12-02T00:00:00Z”,
  “status_mechanism”: “status_list|merkle|accumulator”,
  “base_payload”: {... },
  “delta”: {... },
  “inclusion_proofs”: [... ],
  “signature”: “Sig(status_publisher_key, H(core_fields))”
}
```

FIG. 12 illustrates the contents of an Offline Verifier Bundle (OVB) and the epoch/delta structure of a Revocation Snapshot Package (RSP), in accordance with one or more example embodiments of the present disclosure. The OVB is organized into two primary sections: Trust Anchors and Revocation Snapshot Packages. The Trust Anchors section contains one or more public keys of authorized status publishers, which serve as the cryptographic foundation for verifying the authenticity and integrity of the revocation data contained within the RSPs.

The Revocation Snapshot Packages section contains one or more RSPs, each representing a signed status package associated with a specific time period. Each RSP includes several components organized in a hierarchical structure. The Epoch field identifies the specific epoch, shown as epoch 4102 in the illustrated example. The Epoch Time Range defines the temporal boundaries of the snapshot through an epoch start value and an epoch end value, establishing the period during which the status information is considered valid. The Status Mechanism field indicates the type of status representation used, which may be a status list, Merkle tree, or accumulator, depending on the implementation specifications and scalability considerations.

The RSP further includes a Base Payload containing the foundational status data for the epoch. A Delta from Previous Epoch field stores incremental changes from the prior epoch, which reduces data transmission by allowing validators to update their local state without downloading the complete status information for each epoch. The RSP also includes Inclusion Proofs that enable verification of specific status entries within the data structure, allowing a validator to confirm whether a particular credential or assertion has been revoked without requiring access to the complete status dataset.

At the bottom of the RSP structure is a Digital Signature section containing a digital signature signed by the Status Publisher Key over a hash of the core fields. This signature ensures the integrity and authenticity of the RSP data, allowing the validator to confirm that the RSP was issued by an authorized status publisher and has not been tampered with since issuance. This structure enables the validator within the SDK module 430 to perform offline validation by selecting an appropriate RSP from the OVB and enforcing freshness constraints specified in the verification plan object without requiring a network connection at the time of validation.

As detailed in the algorithm of FIG. 13, when performing offline validation, the validator within the SDK module 430 selects a best-available RSP from the OVB. The validator then enforces the freshness plan from the VPO by denying authorization if the selected RSP's epoch is less than the minimum_epoch specified in the VPO, or if the time since the RSP's epoch_end exceeds the maximum_staleness specified in the VPO (considering any grace period). This denial of authorization based on freshness failure occurs even if the cryptographic proof of the VP itself otherwise verifies. This process may also be used in a hybrid mode as shown in FIG. 17.

FIG. 13 illustrates a flowchart of an offline validation algorithm including a revocation freshness gate and replay protection, in accordance with one or more example embodiments of the present disclosure. The algorithm begins at step 1300, which initiates the validation sequence. At step 1302, the system receives a verifiable presentation from a user seeking authorization. The process then proceeds to step 1304, where a revocation snapshot package is selected from the offline verifier bundle for validation purposes.

At step 1306, the system determines whether the cryptographic proof contained within the verifiable presentation is valid. If the cryptographic proof is not valid, the process moves to step 1308, where authorization is denied. If the cryptographic proof is valid, the process continues to step 1310, where verification plan constraints from the VPO are loaded into the validator.

The process then advances to step 1312, which checks whether the selected revocation snapshot is within the freshness window specified by the freshness plan. This step enforces the minimum epoch and maximum staleness constraints. If the revocation snapshot is not within the freshness window, the process proceeds to step 1314, where authorization is denied regardless of whether the cryptographic proof otherwise verified. If the revocation snapshot is within the freshness window, the process moves to step 1316, where replay protection is checked to prevent reuse of previously submitted presentations.

At step 1318, the system determines whether the replay check has passed. If the replay check has not passed, the process proceeds to step 1320, where authorization is denied. If the replay check has passed, the process continues to step 1322, where final conformance checks are applied to ensure all policy conditions have been satisfied.

At step 1324, the system determines whether the conformance checks have passed. If the conformance checks have not passed, the process moves to step 1326, where authorization is denied. If the conformance checks have passed, the process proceeds to step 1328, where an authorization allow decision is output by the validator. Following the successful authorization, the process advances to step 1330, where the feature set controlled by the conformance gate is enabled for the user.

All denial paths from steps 1308, 1314, 1320, and 1326 converge at step 1332, where an authorization deny decision is output. The process concludes at step 1334, which marks the end of the validation algorithm. The flowchart demonstrates a multi-stage validation approach that enforces cryptographic verification, revocation freshness constraints, replay protection, and conformance checks before enabling features, with authorization being denied at any stage where validation criteria are not satisfied.

### Gaming SDK Adapter Enforcement Points (FIG. 14)

FIG. 14 illustrates gaming SDK adapter enforcement points, including achievement/reputation gating and anti-cheat trust gates, in accordance with one or more example embodiments of the present disclosure. The diagram depicts the integration of verification-based access controls within a relying 3D rendering platform 10 through the software development kit module 430.

The software development kit module 430 receives an authorization decision as input and includes a validator 432 that processes this authorization decision. The validator 432 is communicatively coupled to a gaming SDK adapter 1400, which serves as an intermediary layer for applying verification-based access controls to gaming features. The gaming SDK adapter 1400 provides a standardized interface for integrating the verification framework with game-specific functionality.

Within the gaming SDK adapter 1400, an ApplyGate function 1402 receives output from the validator 432. The ApplyGate function 1402 is responsible for routing the authorization decision through appropriate gating mechanisms based on the type of feature being accessed. The ApplyGate function 1402 connects to two gating mechanisms within the gaming SDK adapter 1400: an achievement reputation gating 1404 and an anti-cheat trust gate 1406.

The achievement reputation gating 1404 evaluates whether a user meets reputation or achievement specifications for accessing certain features. This gating mechanism may verify that a user possesses specific achievement assertions or has a reputation score above a predetermined threshold before permitting access to restricted functionality. The anti-cheat trust gate 1406 assesses the trust status of the user with respect to anti-cheat policies, ensuring that users who have been flagged for cheating or other policy violations are appropriately restricted from competitive features.

Both the achievement reputation gating 1404 and the anti-cheat trust gate 1406 feed into a conformance gate 1408, which is depicted as a decision point within the software development kit module 430. The conformance gate 1408 determines whether to enable or disable access to downstream gameplay features based on the combined evaluation from the gating mechanisms.

The conformance gate 1408 controls access to three gameplay features shown outside the software development kit module 430: competitive matchmaking 1410, ranked rewards 1412, and asset trading marketplace 1414. The competitive matchmaking 1410 represents functionality for pairing users in competitive game modes, which may involve verification of reputation or trust status before participation. The ranked rewards 1412 represents functionality for distributing rewards based on competitive performance, which may be gated based on achievement verification. The asset trading marketplace 1414 represents functionality for trading digital assets between users, which may involve ownership verification before enabling trading capabilities.

The system operates by processing the authorization decision through the validator 432, applying the ApplyGate function 1402 to route the decision through the appropriate gating mechanisms, and using the conformance gate 1408 to selectively enable or disable the gameplay features based on whether the user satisfies conditions. This architecture ensures that sensitive gaming features are protected by verification requirements while maintaining a seamless user experience for authorized users.

### Unified Gamer Identity Interoperability Layer (FIG. 15)

In gaming embodiments, as illustrated in FIG. 15, the system 400 may implement a unified gamer identity interoperability layer. This layer comprises: (a) a schema registry storing normalized schemas for achievement and reputation assertions, and mappings from game-specific events to said normalized schemas; (b) issuer scope rules defining which issuer systems are authorized to issue which types of assertions; and (c) a reputation aggregation rule engine configured to compute a derived reputation assertion from a plurality of validated assertions according to a deterministic aggregation rule. This layer ensures that achievements and reputation are meaningful and comparable across different gaming platforms.

FIG. 15 illustrates a cross-game interoperability layer, including a schema registry, issuer scopes, achievement normalization, and reputation aggregation, in accordance with one or more example embodiments of the present disclosure. The diagram depicts the verification and feature enablement process that enables unified gamer identity across multiple gaming platforms.

The process begins with a verifiable presentation 1500, which is provided as input to a validator 1502. The verifiable presentation 1500 contains assertion records that may include achievement claims, reputation metrics, or ownership proofs from one or more gaming platforms. The validator 1502 processes the verifiable presentation 1500 by verifying cryptographic signatures and checking the validity of the contained assertions against the schema registry.

The validator 1502 forwards the verified presentation to a policy evaluation engine 1504. The policy evaluation engine 1504 evaluates the presentation against applicable policies, including issuer scope rules that define which issuer systems are authorized to issue specific types of assertions. The policy evaluation engine 1504 also applies achievement normalization mappings from the schema registry to translate game-specific achievement events into normalized schemas that are comparable across different gaming platforms. Additionally, the policy evaluation engine 1504 may invoke the reputation aggregation rule engine to compute a derived reputation score from multiple validated assertions according to deterministic aggregation rules.

The policy evaluation engine 1504 produces an enforcement decision 1506, which represents a decision point in the process. If the enforcement decision 1506 results in a negative outcome, the process proceeds to deny authorization 1508. Following deny authorization 1508, the process moves to disable feature set 1510, which restricts access to certain platform features for the user.

If the enforcement decision 1506 results in a positive outcome, the process proceeds to allow authorization 1512. Following allow authorization 1512, the process moves to ApplyGate execution 1514, which initiates the gate application mechanism within the gaming SDK adapter. The ApplyGate execution 1514 then proceeds to a conformance gate 1516, which verifies compliance with platform-specific specifications and ensures that the user satisfies all conditions for accessing protected features.

Upon successful passage through the conformance gate 1516, the process reaches a feature enablement module 1518. The feature enablement module 1518 enables access to multiple platform features based on the verified assertions. These features include competitive matchmaking 1520, which allows users to participate in competitive game modes based on verified reputation or achievement status. The features also include ranked rewards 1522, which enables distribution of rewards based on competitive performance where the user has demonstrated verified achievements. Additionally, the features include asset trading marketplace 1524, which permits trading of digital assets between users where ownership has been verified through the interoperability layer.

The unified gamer identity interoperability layer ensures that achievements earned in one gaming platform can be recognized and utilized in another platform through the normalized schema mappings. The reputation aggregation capabilities allow a user's overall gaming reputation to be computed from achievements and trust metrics across multiple platforms, providing a comprehensive view of the user's standing within the gaming ecosystem.

### Anti-Linkability and Derived Identifiers (FIG. 16)

To reduce cross-service tracking while preserving portability, the system derives pairwise identifiers and keys, as illustrated in FIG. 16. A Pairwise Pseudonymous Identifier (PPID) is derived uniquely per relying application via a function such as HMAC(master_secret, relying_app_id). To prevent correlation, reuse of a PPID across distinct relying_app_id values may be prohibited. Additionally, per-relying-app signing keys may be derived using a key derivation function (KDF) such as HKDF(master_key, relying_app_id).

FIG. 16 illustrates a system architecture diagram depicting anti-linkability features including Pairwise Pseudonymous Identifier (PPID) and per-relying-app key derivation with correlation controls, in accordance with one or more example embodiments of the present disclosure. The system architecture is organized into three primary surfaces: a client surface, a policy service, and external surfaces.

The client surface includes a relying game client 1600 that contains an SDK runtime module 1602. The SDK runtime module 1602 comprises a validator 1604 and an ApplyGate engine 1606. The validator 1604 communicates with the policy service to perform verification operations. The ApplyGate engine 1606 receives input from the validator 1604 and produces an enforcement decision 1626. The enforcement decision 1626 determines whether to follow a deny path leading to disable features 1628 or an allow path leading to a conformance gate 1608. The conformance gate 1608 controls access to a client feature set 1610.

The policy service comprises a policy service 1612 that includes three components: a policy engine 1614, a trust mode selector 1616, and a revocation service 1618. The policy engine 1614 receives communications from the validator 1604 and processes policy-related operations. The trust mode selector 1616 handles trust mode determination for verification processes. The revocation service 1618 manages revocation status information and communicates with the ApplyGate engine 1606.

The external surfaces include three services that interact with the conformance gate 1608: a matchmaking server 1620, a ranked reward service 1622, and an asset marketplace 1624. These external services represent gameplay features that are enabled or disabled based on the authorization decision flowing through the conformance gate 1608. The matchmaking server 1620 handles competitive matchmaking functionality, the ranked reward service 1622 manages ranked rewards distribution, and the asset marketplace 1624 facilitates digital asset trading operations.

The system operates by having the validator 1604 communicate with the policy service 1612 to evaluate verification requests. The ApplyGate engine 1606 then makes an enforcement decision 1626 based on the validation results. When the enforcement decision 1626 follows the deny path, features are disabled via disable features 1628. When the enforcement decision 1626 follows the allow path, the conformance gate 1608 permits access to the client feature set 1610 and enables communication with the external surfaces including the matchmaking server 1620, the ranked reward service 1622, and the asset marketplace 1624.

The anti-linkability features are implemented through the derivation of pairwise pseudonymous identifiers and per-relying-app signing keys within the SDK runtime module 1602. When the relying game client 1600 initiates a verification process, the SDK runtime module 1602 derives a unique PPID for that specific relying application using a function such as HMAC(master\_secret, relying\_app\_id). This ensures that the same user presents different identifiers to different relying applications, preventing cross-service correlation and tracking. The per-relying-app signing keys are similarly derived using a key derivation function such as HKDF(master\_key, relying\_app\_id), ensuring that cryptographic operations performed for one relying application cannot be linked to operations performed for another. This architecture preserves the portability of the user's digital identity while protecting user privacy across the gaming ecosystem.

### Hybrid Mode and Delayed Synchronization (FIG. 17)

As illustrated in FIG. 17, the system may operate in a hybrid mode where centralized services publish status signals and RSPs, while the subject presents user-held proofs. Audit records may be stored locally during offline operation and uploaded when connectivity resumes, subject to privacy controls.

FIG. 17 illustrates a flowchart of a validation process for offline verification combining centralized status signaling with user-held proof, in accordance with one or more example embodiments of the present disclosure. The diagram depicts the hybrid mode validation architecture that enables deterministic enforcement of verification policies even in disconnected environments.

The process receives three inputs: a verifiable presentation 1700, a verification plan object 1702, and an offline verifier bundle 1704. The verifiable presentation 1700 contains the user-held proof generated from assertion records in the portable identity container. The verification plan object 1702 specifies the policy conditions including disclosure plans, proof plans, and freshness constraints. The offline verifier bundle 1704 provides the necessary trust anchors and revocation snapshot packages for offline validation.

These inputs are provided to a validation engine 1706, which comprises several components for processing the verification. Within the validation engine 1706, a cryptographic proof verifier 1708 first processes the inputs to verify the cryptographic integrity of the verifiable presentation 1700. The cryptographic proof verifier 1708 validates signatures and ensures that the proof was generated by an authorized entity.

The process then proceeds to a revocation freshness checker 1710, which evaluates whether the revocation status information satisfies the freshness requirements specified in the verification plan object 1702. The revocation freshness checker 1710 enforces the minimum epoch and maximum staleness constraints by comparing the epoch of the selected revocation snapshot package against the freshness plan parameters. Authorization is denied if the revocation snapshot package fails to satisfy these constraints, even if the cryptographic proof otherwise verifies.

Following this, a replay protection module 1712 checks for replay attacks to prevent reuse of previously submitted presentations. The replay protection module 1712 maintains records of previously processed presentations and rejects any presentation that has been submitted before, ensuring that each verification request is unique.

The validation engine 1706 then reaches a validation decision 1714, which determines the outcome of the verification process based on the results from the cryptographic proof verifier 1708, the revocation freshness checker 1710, and the replay protection module 1712. If the validation decision 1714 results in a negative outcome due to any verification failure, the process proceeds to deny authorization 1716, which subsequently triggers disable feature set 1720 to restrict access to protected features for the user.

If the validation decision 1714 results in a positive outcome where all verification checks pass, the process proceeds to allow authorization 1718. Upon successful authorization, the process continues to a conformance gate 1722, which controls access to protected gameplay features and ensures that the user satisfies all platform-specific conditions.

The conformance gate 1722 enables access to three feature categories upon successful verification. Competitive matchmaking 1724 allows users to participate in competitive game modes based on verified reputation or achievement status. Ranked rewards 1726 enables distribution of rewards based on competitive performance where the user has demonstrated verified achievements. Asset trading marketplace 1728 permits trading of digital assets between users where ownership has been verified through the validation process.

The hybrid mode architecture enables the system to function effectively in environments with intermittent or no network connectivity. Centralized services publish status signals and revocation snapshot packages when connectivity is available, which are stored in the offline verifier bundle 1704. During offline operation, the validation engine 1706 uses these cached materials to perform verification without requiring a network connection. Audit records generated during offline operation may be stored locally and uploaded when connectivity resumes, subject to privacy controls configured in the verification plan object 1702. This delayed synchronization approach ensures that verification can proceed in disconnected environments while maintaining the integrity and auditability of the verification process.

In accordance with the present disclosure, a computer-implemented system for managing a digital avatar and verifying conditions related to the avatar across a plurality of 3D rendering platforms is provided. The system comprises a content database 410 configured to store a 3D model of the digital avatar and one or more associated digital assets. The system further comprises a user account module 450 configured to record ownership of the one or more digital assets for a user on a distributed ledger 452, the ownership being stored as one or more assertion records in a portable identity container 901 associated with the user. The system further comprises an Application Programming Interface (API) module 440 configured to receive, from a relying 3D rendering platform 10, a verification request (VRQ) to verify a condition about the user, and in response to the VRQ, generate a verification plan object (VPO). The VPO specifies at least a disclosure plan defining permitted fields for disclosure, and a freshness plan specifying at least one of a minimum epoch or a maximum staleness for revocation status. The system further comprises a software development kit (SDK) module 430 configured for integration into the relying 3D rendering platform 10, the SDK module 430 comprising a validator 432 and a conformance gate 1408. The validator 432 is configured to receive a verifiable presentation (VP) generated from an assertion record in the portable identity container 901, validate the VP against the VPO including enforcing the freshness plan by denying authorization when a selected revocation snapshot package (RSP) fails to satisfy the minimum epoch or the maximum staleness, and output an authorization decision. The conformance gate 1408 is configured to enable or disable at least one gameplay feature of the relying 3D rendering platform 10 based on the authorization decision.

In one or more embodiments, the validator 432 is configured to perform offline validation using an offline verifier bundle (OVB) comprising at least one signed revocation snapshot package (RSP). The OVB provides the necessary trust anchors and revocation snapshot packages for offline validation, enabling the system to function effectively in environments with intermittent or no network connectivity.

In one or more embodiments, the VPO further specifies a trust-mode plan selected by applying a stored precedence rule table 1104 that maps at least one of partner policy, jurisdiction, risk classification, or network state to a selected verification mode. The stored precedence rule table 1104 ensures deterministic and auditably reproducible trust-mode selection.

In one or more embodiments, the user account module 450 is further configured to derive a pairwise pseudonymous identifier (PPID) 910 for the user for each relying 3D rendering platform 10 to reduce cross-platform correlation. The PPID 910 is derived uniquely per relying application via a function such as HMAC(master\_secret, relying\_app\_id), ensuring that the same user presents different identifiers to different relying applications.

In one or more embodiments, the system further comprises a schema registry configured to store normalized schemas for achievement and reputation assertions, wherein the validator 432 is further configured to deny authorization if a verifiable presentation uses a schema not compliant with the schema registry. This ensures that achievements and reputation are meaningful and comparable across different gaming platforms.

In one or more embodiments, the freshness plan specifies a grace\_seconds parameter, and the validator 432 considers the grace period when determining if the maximum staleness has been exceeded. This provides flexibility in enforcement while maintaining security guarantees.

In one or more embodiments, the content delivery module 420 is configured to utilize a content delivery network (CDN) to deliver the 3D model of the digital avatar and the associated digital assets based on a geographical location of the user. This ensures optimal performance and quick response times for content delivery.

In one or more embodiments, the SDK module 430 is further configured to fetch one or more second digital assets utilized by the user for customization of the avatar at runtime, and the user account module 450 is configured to record ownership of the one or more second digital assets on the distributed ledger 452. This enables users to acquire new customization assets while using the 3D rendering platforms 10 and have those assets securely recorded.

In one or more embodiments, the system further comprises a multi-application caching module 460 configured to consolidate duplicate entries of the 3D model of the digital avatar and the associated digital assets into a single unified cache entry on a user device 300. This optimizes storage and enhances the overall performance of the user device 300.

In one or more embodiments, the one or more digital assets comprise at least one of: a separate layer of clothing, a facial feature, a hair texture, an accessory, or music. These assets enable users to create unique and distinctive appearances for their avatars.

In one or more embodiments, the condition to be verified by the validator 432 is entitlement to use a specific digital asset in the relying 3D rendering platform 10, and upon a successful authorization decision from the conformance gate 1408, the content delivery module 420 delivers the 3D model of the specific digital asset from the content database 410 to the SDK module 430 for rendering at runtime. This integrates the verification framework with the avatar management system to create a unified trusted digital identity.

In one or more embodiments, the gameplay feature enabled or disabled by the conformance gate 1408 is competitive matchmaking 1410, and the condition verified by the validator 432 is a reputation assertion with a score above a predetermined threshold, the reputation assertion having been computed by a reputation aggregation rule engine based on a plurality of assertion records from different 3D rendering platforms 10. This ensures that competitive features are protected by verification requirements.

In one or more embodiments, the verifiable presentation is a zero-knowledge predicate proof proving ownership of a digital asset recorded on the distributed ledger 452, without disclosing the identity of the user or the underlying asset details beyond what is specified in the disclosure plan of the VPO. This provides privacy-preserving verification capabilities.

In one or more embodiments, the VPO is cryptographically bound to the VRQ by including a hash of the VRQ in a signature over the VPO. This prevents replay and context substitution attacks.

In one or more embodiments, the RSP includes a delta update from a previous epoch and one or more inclusion proofs for a status identifier. This reduces data transmission requirements by allowing validators to update their local state without downloading the complete status information for each epoch.

In one or more embodiments, the conformance gate 1408, upon a failed authorization decision, denies a user access to a competitive queue within the relying 3D rendering platform 10. This ensures that sensitive gaming features are protected by verification requirements.

In one or more embodiments, the assertion record is an achievement assertion normalized by a schema registry, and the gameplay feature enabled by the conformance gate 1408 is access to a trading marketplace for digital assets. This enables cross-platform recognition of achievements.

In accordance with the present disclosure, a computer-implemented method for managing a digital avatar and verifying conditions related to the avatar across a plurality of 3D rendering platforms is provided. The method comprises storing, in a content database 410, a 3D model of the digital avatar and one or more associated digital assets. The method further comprises recording, by a user account module 450, ownership of the one or more digital assets for a user on a distributed ledger 452, the ownership being stored as one or more assertion records in a portable identity container 901 associated with the user. The method further comprises receiving, by an API module 440 from a relying 3D rendering platform 10, a verification request (VRQ) to verify a condition about the user. The method further comprises generating, by the API module 440 in response to the VRQ, a verification plan object (VPO), wherein the VPO specifies at least a disclosure plan and a freshness plan. The method further comprises validating, by a validator 432 within a SDK module 430 integrated into the relying 3D rendering platform 10, a verifiable presentation (VP) generated from an assertion record in the portable identity container 901, wherein said validating includes enforcing the freshness plan by denying authorization when a selected revocation snapshot package (RSP) fails to satisfy at least one of a minimum epoch or a maximum staleness specified in the freshness plan. The method further comprises outputting, from the validator 432, an authorization decision. The method further comprises enabling or disabling, by a conformance gate 1408 in the SDK module 430, at least one gameplay feature of the relying 3D rendering platform 10 based on the authorization decision.

In one or more embodiments, said validating is performed offline using an offline verifier bundle (OVB) stored by, or accessible to, the relying 3D rendering platform 10. This enables verification in disconnected environments.

In one or more embodiments, generating the VPO further comprises selecting a trust-mode plan by applying a stored precedence rule table 1104 that maps at least one of partner policy, jurisdiction, or risk classification to a selected verification mode. This ensures deterministic mode selection.

In one or more embodiments, the condition to be verified is entitlement to use a specific digital asset, the method further comprising, upon a successful authorization decision, delivering the 3D model of the specific digital asset from the content database 410 to the SDK module 430 for rendering at runtime.

In one or more embodiments, the method further comprises deriving, by the user account module 450, a pairwise pseudonymous identifier (PPID) 910 for the user for the relying 3D rendering platform 10 to reduce cross-platform correlation.

In accordance with the present disclosure, a non-transitory computer-readable medium storing instructions that, when executed by one or more processors, cause a computer system to perform a method is provided. The method comprises recording, in a portable identity container 901 associated with a user, one or more assertion records representing ownership of one or more digital assets stored on a distributed ledger 452. The method further comprises receiving, from a relying 3D rendering platform 10, a verification request (VRQ) to verify a condition about the user. The method further comprises generating, in response to the VRQ, a verification plan object (VPO) specifying at least a disclosure plan and a freshness plan. The method further comprises validating a verifiable presentation (VP) generated from an assertion record in the portable identity container 901, wherein said validating includes enforcing the freshness plan by denying authorization when a selected revocation snapshot package (RSP) fails to satisfy at least one of a minimum epoch or a maximum staleness specified in the freshness plan. The method further comprises enabling or disabling at least one gameplay feature of the relying 3D rendering platform 10 based on an authorization decision resulting from said validating.

In one or more embodiments, the condition to be verified by said validating comprises entitlement to use a specific digital asset, and the instructions further cause the computer system to perform the method of delivering, upon a successful authorization decision resulting from said validating, the 3D model of the specific digital asset from a content database 410 to the relying 3D rendering platform 10 for rendering at runtime.

In an aspect, a system for cross-platform delivery and management of a 3D model of an avatar and associated assets is disclosed. The system comprises at least one content delivery module configured to deliver the 3D model of the avatar and associated assets to a plurality of 3D rendering platforms, at least one software development kit (SDK) module configured to interface with an in-engine avatar customization module at a runtime of a 3D rendering platform, at least one multi-application caching module configured to store the 3D model of the avatar and associated assets for reuse across multiple 3D rendering platforms, and at least one content database configured to store the 3D model of the avatar, associated assets, and related metadata.

In an aspect, a computer-implemented method for cross-platform delivery and management of a 3D model of an avatar and associated assets is disclosed. The method comprises delivering, by a content delivery module, the 3D model of the avatar and associated assets to a plurality of 3D rendering platforms. The method further comprises interfacing, by a software development kit (SDK) module, with an in-engine avatar customization module at a runtime of a 3D rendering platform. The method further comprises storing, by a multi-application caching module, the 3D model of the avatar and associated assets for reuse across multiple 3D rendering platforms. The method further comprises storing, in a content database, the 3D model of the avatar, associated assets, and related metadata.

In one or more aspects, the SDK module is configured to fetch one or more second assets utilized by the user for customization of the avatar as available in and by implementation of the corresponding in-engine avatar customization module at the runtime.

In one or more aspects, the multi-application caching module is further configured to consolidate duplicate entries of the avatar and associated assets into a single unified cache entry.

In one or more aspects, the multi-application caching module is further configured to synchronize the unified cache entry with each of the multiple 3D rendering platforms.

In one or more aspects, the multi-application caching module is configured to regularly check for outdated or unused avatar models and assets and remove them from the cache storage.

In one or more aspects, the content database is configured to store metadata associated with each avatar and asset, the metadata comprising at least asset type, asset category, asset creator information, and asset ownership information.

In one or more aspects, the content database supports versioning of avatar assets to enable users to revert to a previous version of the avatar or an asset.

In one or more aspects, the content database includes access control mechanisms comprising at least authentication and encryption to restrict access to avatar data and associated assets.

In one or more aspects, the SDK module is configured to account for differences in how assets are rendered, handled, or animated across different 3D rendering platforms.

In one or more aspects, the method further comprises using a caching mechanism in the content delivery module to store frequently requested 3D models of avatars and assets to reduce access latency.

In one or more aspects, the method further comprises consolidating multiple instances of the same avatar or asset on the user device into a single cache entry using a multi-application caching module.

In one or more aspects, the method further comprises synchronizing a unified cache entry of the avatar and assets across the multiple 3D rendering platforms to maintain consistency.

In one or more aspects, the method further comprises periodically removing unused or outdated avatar models and assets from the user device cache using a multi-application caching module.

In one or more aspects, the method further comprises storing, in the content database, metadata for each avatar and associated asset, the metadata including at least asset type and ownership information.

In one or more aspects, the method further comprises storing multiple versions of an avatar or asset to enable reversion to a prior version.

In one or more aspects, the method further comprises authenticating access to avatar data stored in the content database based on user credentials.

In one or more aspects, the method further comprises adapting the 3D model and associated assets in the SDK module based on specifications of the in-engine avatar customization module.

In one or more aspects, the 3D rendering platforms include at least one of: a video game, a metaverse, or a social virtual reality application, and the user device comprises at least one of: a personal computer, a smartphone, a gaming console, a portable gaming device, a headset, or a heads-up display.

The foregoing descriptions of specific embodiments of the present disclosure have been presented for purposes of illustration and description. Those are not intended to be exhaustive or to limit the present disclosure to the precise forms disclosed, and obviously many modifications and variations are possible in light of the above teaching. The example embodiments have been chosen and described in order to best explain the principles of the present disclosure and its practical applications, to thereby enable others skilled in the art to best utilize the present disclosure and various embodiments with various modifications as are suited to the particular use contemplated. Modifications to embodiments of the present disclosure described in the foregoing are possible without departing from the scope of the present disclosure as defined by the accompanying claims.

1. A computer-implemented system for managing a digital avatar and verifying conditions related to the avatar across a plurality of 3D rendering platforms, the system comprising:
a content database configured to store a 3D model of the digital avatar and one or more associated digital assets;
a user account module configured to record ownership of the one or more digital assets for a user on a distributed ledger, the ownership being stored as one or more assertion records in a portable identity container (PIC) associated with the user;
an Application Programming Interface (API) module configured to:
receive, from a relying 3D rendering platform, a verification request (VRQ) to verify a condition about the user; and
in response to the VRQ, generate a verification plan object (VPO), wherein the VPO specifies at least:
a disclosure plan defining permitted fields for disclosure, and
a freshness plan specifying at least one of a minimum epoch or a maximum staleness for revocation status; and
a software development kit (SDK) module configured for integration into the relying 3D rendering platform, the SDK module comprising:
a validator configured to:
(a) receive a verifiable presentation (VP) generated from an assertion record in the PIC,
(b) validate the VP against the VPO, including enforcing the freshness plan by denying authorization when a selected revocation snapshot package (RSP) fails to satisfy the minimum epoch or the maximum staleness, and
(c) output an authorization decision; and
a conformance gate configured to enable or disable at least one gameplay feature of the relying 3D rendering platform based on the authorization decision.

2. The system of claim 1, wherein the validator is configured to perform offline validation using an offline verifier bundle (OVB) comprising at least one signed revocation snapshot package (RSP).

3. The system of claim 1, wherein the VPO further specifies a trust-mode plan selected by applying a stored precedence rule table that maps at least one of partner policy, jurisdiction, risk classification, or network state to a selected verification mode.

4. The system of claim 1, wherein the user account module is further configured to derive a pairwise pseudonymous identifier (PPID) for the user for each relying 3D rendering platform to reduce cross-platform correlation.

5. The system of claim 1, further comprising a schema registry configured to store normalized schemas for achievement and reputation assertions, wherein the validator is further configured to deny authorization if a verifiable presentation uses a schema not compliant with the schema registry.

6. The system of claim 1, wherein the freshness plan specifies a grace_seconds parameter, and wherein the validator considers a grace period when determining if the maximum staleness has been exceeded.

7. The system of claim 1, wherein a content delivery module is configured to utilize a content delivery network (CDN) to deliver the 3D model of the digital avatar and the associated digital assets based on a geographical location of the user.

8. The system of claim 1, wherein the SDK module is further configured to fetch one or more second digital assets utilized by the user for customization of the avatar at runtime, and wherein the user account module is configured to record ownership of the one or more second digital assets on the distributed ledger.

9. The system of claim 1, further comprising a multi-application caching module configured to consolidate duplicate entries of the 3D model of the digital avatar and the associated digital assets into a single unified cache entry on a user device.

10. The system of claim 1, wherein the one or more digital assets comprise at least one of: a separate layer of clothing, a facial feature, a hair texture, an accessory, or music.

11. The system of claim 1, wherein the condition to be verified by the validator is entitlement to use a specific digital asset in the relying 3D rendering platform, and wherein, upon a successful authorization decision from the conformance gate, a content delivery module delivers the 3D model of the specific digital asset from the content database to the SDK module for rendering at runtime.

12. The system of claim 1, wherein the gameplay feature enabled or disabled by the conformance gate is competitive matchmaking, and wherein the condition verified by the validator is a reputation assertion with a score above a predetermined threshold, the reputation assertion having been computed by a reputation aggregation rule engine based on a plurality of assertion records from different 3D rendering platforms.

13. The system of claim 1, wherein the verifiable presentation is a zero-knowledge predicate proof proving ownership of a digital asset recorded on the distributed ledger, without disclosing the identity of the user or underlying asset details beyond what is specified in the disclosure plan of the VPO.

14. The system of claim 1, wherein the VPO is cryptographically bound to the VRQ by including a hash of the VRQ in a signature over the VPO.

15. The system of claim 2, wherein the RSP includes a delta update from a previous epoch and one or more inclusion proofs for a status identifier.

16. The system of claim 1, wherein the conformance gate, upon a failed authorization decision, denies a user access to a competitive queue within the relying 3D rendering platform.

17. The system of claim 1, wherein the assertion record is an achievement assertion normalized by a schema registry, and wherein the gameplay feature enabled by the conformance gate is access to a trading marketplace for digital assets.

18. A computer-implemented method for managing a digital avatar and verifying conditions related to the avatar across a plurality of 3D rendering platforms, the method comprising:
storing, in a content database, a 3D model of the digital avatar and one or more associated digital assets;
recording, by a user account module, ownership of the one or more digital assets for a user on a distributed ledger, the ownership being stored as one or more assertion records in a portable identity container (PIC) associated with the user;
receiving, by an Application Programming Interface (API) module from a relying 3D rendering platform, a verification request (VRQ) to verify a condition about the user;
generating, by the API module in response to the VRQ, a verification plan object (VPO), wherein the VPO specifies at least a disclosure plan and a freshness plan;
validating, by a validator within a software development kit (SDK) module integrated into the relying 3D rendering platform, a verifiable presentation (VP) generated from an assertion record in the PIC, wherein said validating includes enforcing the freshness plan by denying authorization when a selected revocation snapshot package (RSP) fails to satisfy at least one of a minimum epoch or a maximum staleness specified in the freshness plan;
outputting, from the validator, an authorization decision; and
enabling or disabling, by a conformance gate in the SDK module, at least one gameplay feature of the relying 3D rendering platform based on the authorization decision.

19. The method of claim 18, wherein said validating is performed offline using an offline verifier bundle (OVB) stored by, or accessible to, the relying 3D rendering platform.

20. The method of claim 18, wherein generating the VPO further comprises selecting a trust-mode plan by applying a stored precedence rule table that maps at least one of partner policy, jurisdiction, or risk classification to a selected verification mode.

21. The method of claim 18, wherein the condition to be verified is entitlement to use a specific digital asset, the method further comprising, upon a successful authorization decision, delivering the 3D model of the specific digital asset from the content database to the SDK module for rendering at runtime.

22. The method of claim 18, further comprising deriving, by the user account module, a pairwise pseudonymous identifier (PPID) for the user for the relying 3D rendering platform to reduce cross-platform correlation.

23. A non-transitory computer-readable medium storing instructions that, when executed by one or more processors, cause a computer system to perform a method, the method comprising:
recording, in a portable identity container (PIC) associated with a user, one or more assertion records representing ownership of one or more digital assets stored on a distributed ledger;
receiving, from a relying 3D rendering platform, a verification request (VRQ) to verify a condition about the user;
generating, in response to the VRQ, a verification plan object (VPO) specifying at least a disclosure plan and a freshness plan;
validating a verifiable presentation (VP) generated from an assertion record in the PIC, wherein said validating includes enforcing the freshness plan by denying authorization when a selected revocation snapshot package (RSP) fails to satisfy at least one of a minimum epoch or a maximum staleness specified in the freshness plan; and
enabling or disabling at least one gameplay feature of the relying 3D rendering platform based on an authorization decision resulting from said validating.

24. The non-transitory computer-readable medium of claim 23, wherein the condition to be verified by said validating comprises entitlement to use a specific digital asset, and wherein the instructions further cause the computer system to perform the method of:
delivering, upon a successful authorization decision resulting from said validating, the 3D model of the specific digital asset from a content database to the relying 3D rendering platform for rendering at runtime.
